(19) United States
(12) Patent Application Publication
(10) Pub. No.: US 2011/0011595 A1
(43) Pub. Date: Jan. 20, 2011

(54) Modeling of Hydrocarbon Reservoirs Using Design of Experiments Methods

(76) Inventors: Hao Huang, Houston, TX (US); Sheng-Yuan Hsu, Sugar Land, TX (US); Jason A. Burdette, Houston, TX (US); Marcus Asmann, Pearland, TX (US)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/920,948

(22) PCT Filed: Mar. 3, 2009
(86) PCT No.: PCT/US09/35855

§ 371 Date: Sep. 3, 2010

Related U.S. Application Data
(60) Provisional application No. 61/127,626, filed on May 13, 2008.

(51) Int. Cl. E21B 43/00; G06G 7/48; G06G 7/57

(52) U.S. Cl. 166/369; 703/6; 703/10

(57) ABSTRACT

Methods for generating a surrogate model for subsurface analysis may include identifying input parameters for the subsurface analysis, and selecting a range of values for the identified parameters. The methods also include selecting a design of experiments method for filling sampling points within the ranges of values for the identified input parameters. The design of experiments method may be a classical method or a space-filling technique. The methods also include filling sampling points within the ranges of values for the identified input parameters. The sampling points are filled based on the design of experiments method selected. The methods further include acquiring output values for each of the selected sampling points, and constructing a surrogate model based upon the output values for at least some of the selected sampling points. The surrogate model is a mathematical equation that represents a simplified model for predicting solutions to complex reservoir engineering problems.

### CROSS REFERENCE TO RELATED APPLICATIONS

This application claims the benefit of U.S. Provisional Application No. 61/127,626, filed 13 May 2008, which is incorporated herein in its entirety for all purposes.

### BACKGROUND

1. Field

The present invention relates to the field of reservoir modeling. More specifically, the present invention relates to the modeling of hydrocarbon-bearing subsurface reservoirs using design of experiments methods.

2. Background

The production of hydrocarbons, such as oil and gas, has been performed for numerous years and in many countries. To produce hydrocarbons, producer wells are drilled into a subsurface formation of a field. Each producer well comprises a borehole that is formed through the earth surface and down to one or more selected formations. The boreholes may be vertical or they may be deviated in order to reach a tangential subsurface location.

The producer wells are completed using long tubular members that serve as casing. A series of casing strings is typically run into the borehole and cemented into place. The casing strings serve to isolate the borehole from the various surrounding subsurface formations and to prevent the migration of formation fluids across adjacent strata.

Each producer well is completed at the level of a hydrocarbon reservoir. Various items of hardware such as pumps, sand screens, packers, control valves and other devices may be installed as part of the completion process. In addition, downhole sensors may be provided to monitor temperature, pressure, fluid flow rate or other reservoir parameters.

It is desirable to perform computer modeling on hydrocarbon reservoirs in order to simulate and predict fluid hydrocarbon flow from producer wells. Such simulations are oftentimes based on mathematical formulations that are assumed to govern the interrelationship of various parameters. These parameters may be reservoir fluid properties, reservoir rock properties, and in situ reservoir conditions.

It is also desirable to perform computer modeling on hydrocarbon reservoirs in order to simulate and predict the injectibility of a formation adjacent an injector well. Parameters that affect injectibility include reservoir rock properties and in situ reservoir conditions.

It is also desirable to perform computer modeling on hydrocarbon reservoirs in order to simulate and predict the operable limits of a producer well or an injector well. The phrase “operability limits” generally refers to the ability of the well to withstand changes in geomechanical stresses below the surface. Parameters that affect operability include reservoir rock properties, in situ reservoir conditions, completion design, and well design.

Numerical methods are often employed to simulate and analyze activities associated with hydrocarbon recovery, fluid injection or operability limits. Numerical methods typically include finite element analysis and finite volume analysis. Such analyses represent an approximate numerical solution to a complex differential equation.

In finite element analysis for reservoir modeling, a geological system under study is divided into a number of individual sub-regions or elements. Creating the elements entails gridding or “meshing” the formation. A mesh is a collection of elements that fill a space, with the elements being representative of a system residing in that space. The process of dividing a production area under study into elements may be referred to as “discretization” or “mesh generation.”

Finite element methods also use a system of points called nodes. The nodes are placed on geometric shapes which define the elements. The elements are programmed to contain the material and structural properties which govern how the structure will react to certain loading conditions. For reservoir modeling, changes to the geological system are predicted as fluid pressures or other reservoir parameters change. This means that a value for a parameter may be approximated at a particular location by determining that value within its element.

A range of variables can be used in finite element analysis for modeling a reservoir. For fluid flow modeling, reservoir parameters typically include permeability, pressure, porosity and, perhaps, temperature. For geomechanical modeling such parameters may include various rock properties such as Poisson's ratio, the modulus of elasticity, shear modulus, Lame' constant, or combinations thereof. Recently, coupled physics simulators have been in development. Such simulators seek to combine the effects of both fluid flow parameters and geomechanics to generate reservoir responses.

It is noted that finite element analyses in the context of hydrocarbon reservoir modeling requires considerable mathematical training and technical expertise. This expertise is limited to very few individuals, that is, individuals who have knowledge of reservoir fluid flow mechanics, geomechanics, and mathematical modeling of dynamic bodies. In addition, significant computing resources are required to prepare and run combined mathematical simulators using finite element analysis. For example, a coupled reservoir-geomechanical analysis to provide earth subsidence estimates can take upwards of three man-months of expert time, not to mention the need for specialized software and powerful computers that can implement finite element equations.

To evaluate reservoir performance in the presence of multiple variables, the concept of surrogate modeling has been developed. One type of surrogate modeling is response surface methodolology. This methodology is described in connection with International Patent Publication Nos. WO2007/018860 and WO2007/018862, each of which was published on Feb. 15, 2007. Each of these applications is entitled “Well Modeling Associated With Extraction of Hydrocarbons from Subsurface Formations.” These two applications are referred to and incorporated herein by reference in their entireties.

Response surface methodolology, or “RSM,” is a systematic approach for minimizing the number of simulation runs needed to meet desired objectives. For example, in reservoir modeling an objective might be to determine a well operability limit, that is, the amount of mechanical stress that may be imposed upon the hardware in a wellbore before a failure is likely to occur. Another objective might be to determine an optimum well producibility, that is, the best production conditions for maximizing recovery or completion efficiency from a given well or set of wells.

Response surface methodology has different names depending upon the field of application. Terms such as “metamodels,” “black box models,” “emulators” or “surrogate models” have been employed. Regardless of the name, a model is constructed based on the simulated responses of a computer-driven simulator to a limited number of intelligently chosen data points. When a solution is desired based on a particular set of data points, the solution may be acquired by interpolating from previous results rather than by re-running the model. Thus, RSM provides an estimated solution to a problem based upon past experiences without having to run a model for every new or “what-if” scenario.

The scientific challenge of surrogate modeling is the generation of a surrogate algorithm that requires as few simulation evaluations as possible to generate a reasonably accurate model. This challenge grows as the number of variables governing the solutions grows. Such an approach has not been undertaken in the context of reservoir simulation, which brings its own unique combination of variables.

Therefore, a need exists for a surrogate modeling method that allows the reservoir analyst to perform complex, multi-variable analyses without running numerous detailed, time consuming reservoir simulations. A need further exists for the application of experimental design techniques to response surface methodology or other surrogate modeling in the context of reservoir analysis. A need further exists for a response surface methodology that enables the reservoir analyst to employ a greater number of variables in order to appropriately capture the physics of a reservoir simulation. Still further, a need exists for a numerical method that offers an efficient technique to fill out the design space for the purpose of developing response surface equations or surrogate models for subsurface engineering related studies.

### SUMMARY

A method for generating a surrogate model for subsurface analysis is provided. Preferably, the subsurface analysis relates to a subsurface region that comprises a hydrocarbon reservoir.

The method comprises identifying input parameters for the subsurface analysis, and selecting a range of values for each of the identified input parameters. The method also includes selecting a design of experiments method for filling sampling points within the ranges of values for the identified input parameters. The design of experiments method may be a classical method or a space-filling technique.

The method also includes filling sampling points within the ranges of values for the identified input parameters. The sampling points are filled based on the design of experiments method selected. The method further includes acquiring output values for a plurality of the selected sampling points. A surrogate model is then constructed based upon the output values for at least some of the selected sampling points. This means that the engineering model is converted into a response surface.

The step of acquiring output values for each of the selected sampling points may be done in different ways. For example, the step may comprise running a plurality of computer-implemented simulations having pre-determined values for the identified input parameters. In other words, some data points may be acquired by actually running computer-based, computational engineering models for the input parameters at pre-determined values. The step may alternatively comprise acquiring data from field operations at actual values for at least some of the identified input parameters. Alternatively still, the step may comprise acquiring data from laboratory experiments at pre-determined values for at least some of the identified input parameters.

The surrogate model is a mathematical equation that represents a simplified model for predicting solutions to complex reservoir engineering problems. The step of constructing a surrogate model may be performed in various ways. For example, the model may be constructed by using a polynomial fitting method, a nested surrogates technique, a Kriging method, a neural network method, a cubic spline method or a tessellation method.

The surrogate model may be employed for a number of purposes. For instance, the surrogate model may be used for analysis of well producibility. In this instance, the input parameters may comprise reservoir rock properties, reservoir fluid properties, in situ reservoir conditions, completion design, well design, and well operating conditions. Alternatively, the surrogate model may be constructed for analysis of well operability. In this instance, the input parameters may represent reservoir rock properties, reservoir fluid properties, in situ reservoir conditions, completion design, well design, and well operating conditions. Alternatively still, the surrogate model may be constructed for analysis of well injectibility. In this instance, the input parameters may include injection fluid properties, reservoir rock properties, reservoir fluid properties, in situ reservoir conditions, completion design, well design, and well operating conditions.

A method associated with the production of hydrocarbons is also provided herein. In one embodiment, the method includes identifying input parameters for operability of a well that penetrates at least one hydrocarbon-bearing formation, and selecting a range of values for each of the identified input parameters. The method may also include selecting a design of experiments method for filling sampling points within the ranges of values for the identified input parameters, and filling sampling points within the ranges of values for the identified input parameters.

A numerical engineering model is constructed to describe an event that results in a wellbore failure mode for the well. The failure mode may comprise determining when shear failure or tensile failure of rock associated with a well completion of the well produces sand. Alternatively, the failure mode may comprise determining one of collapse, crushing, buckling, and shearing of the well due to compaction of reservoir rock as a result of hydrocarbon production. Alternatively still, the failure mode may comprise determining when pressure drop through a near-well completion and in a wellbore of the well hinder the flow of fluids into the wellbore. Further still, the failure mode may comprise determining when pressure drop resulting from flow impairment created by non-Darcy effect, compaction effects, near-wellbore multi-phase flow effects or near-wellbore fines migration effects reduces the flow of fluids from a formation into the well.

The method may also include running the numerical engineering model to acquire output values for a plurality of the selected sampling points. Using one or more selected fitting techniques, a surrogate model is constructed based upon at least some of the output values from the selected sampling points. A surrogate model is then utilized to generate a well operability limit.

Output values for at least some of the selected sampling points may be derived from sources in addition to the engineering model. These include field operations at actual values for at least some of the identified input parameters, and data from laboratory experiments at known values for at least some of the identified input parameters.

Another method associated with the production of hydrocarbons is also provided herein. In one embodiment, the method includes identifying input parameters for producibility of a well that penetrates at least one hydrocarbon-bearing formation, and selecting a range of values for each of the identified input parameters. The method may also include selecting a design of experiments method for filling sampling points within the ranges of values for the identified input parameters, and filling sampling points within the ranges of values for the identified input parameters.

A numerical engineering model is constructed to describe an event associated with production through a wellbore of the well. The method then includes running the numerical engineering model to acquire output values for a plurality of the selected sampling points, constructing a surrogate model based upon at least some of the output values from the selected sampling points, and utilizing the surrogate model to generate a well producibility limit.

### BRIEF DESCRIPTION OF THE DRAWINGS

So that the manner in which the features of the present invention can be better understood, certain graphs, charts and other drawings are appended hereto. It is to be noted, however, that the drawings illustrate only selected embodiments of the inventions and are therefore not to be considered limiting of scope, for the inventions may admit to other equally effective embodiments and applications.

FIG. 1 is an illustrative production system provided for background information. The production system includes a well.

FIG. 2 is an exemplary computer architecture that may be used with certain aspects of the present techniques.

FIG. 3 is an illustrative flow chart showing the development of response surfaces for well operability limits in accordance with certain aspects of the present techniques.

FIG. 4 is an exemplary graph showing well drawdown versus well drainage area depletion of the well in FIG. 1.

FIG. 5 is an illustrative flow chart showing the development of response surfaces for well producibility limits in accordance with certain aspects of the present techniques.

FIGS. 6A and 6B are exemplary charts of well producibility limits of the well in FIG. 1.

FIG. 7 is an illustrative flow chart of the development of coupled physics limits in accordance with aspects of the present techniques.

FIG. 8 is an illustrative graph showing drawdown versus depletion of the well in FIG. 1.

FIG. 9 is an illustrative flow chart showing the optimization of technical limits in accordance with certain aspects of the present techniques.

FIGS. 10A-10C are respective charts of the performance optimization of the well of FIG. 1 in accordance with certain aspects of the techniques herein.

FIG. 11A is a plot of sampling points for a two-parameter study generated using a classical design of experiments method.

FIG. 11B is a plot of sampling points for a three-parameter study generated using a classical design of experiments method.

FIG. 12A is a plot of sampling points for a two-parameter study generated using a Latin hypercube space-filling method.

FIG. 12B is another plot of sampling points for a two-parameter study generated using a Latin Hypercube space-filling method. In this instance, the spacing of the grid lines has been adjusted to concentrate the sampling points more closely towards the center of the plot.

FIG. 13 is a flow chart presenting steps for a method of generating a surrogate model for near-wellbore, subsurface analysis of the present invention, in one embodiment.

FIG. 14 is a Cartesian coordinate charting a shear failure indicator against an unconfined compressive strength. The unconfined compressive strength is non-dimensionalized by dividing the maximum principle effective in situ stress.

FIG. 15 is another Cartesian coordinate. Here, a predicted shear failure indicator using a response surface methodology is compared with predicted shear failure indications computed through the finite element method.

### DETAILED DESCRIPTION OF CERTAIN EMBODIMENTS

### Definitions

“Strain” means a measure of the extent to which a body of material is deformed and/or distorted when it is subjected to a stress-inducing force. “Stress-Inducing Force” refers to an action of at least one force, load and/or constraint on a body of material that tends to strain the body. Examples of the body's deformation or distortion can include, without limitation, changes in the body's length (e.g., linear strain), volume (e.g., bulk strain) and/or a lateral displacement between two substantially parallel planes of material within the body (e.g., shear strain).

“Stress” is a measure of inter-particle forces arising within a body of material resisting deformation and/or distortion, in response to a stress-inducing force applied to the body, as particles within the body of material work to resist separation, compression and/or sliding.

“Principal Stress” means any one of three inherent normal stresses, each perpendicular to the other, in a predetermined coordinate system where the three corresponding shear stresses are equal to zero. Generally, though not always, one of the principal stresses is substantially vertical in a formation, while the two remaining principal stresses are substantially horizontal. While there is no requirement for the principal stresses to be vertical or horizontal, for ease of discussion herein, the three principal stresses, may be referred to as principal vertical stress, σᵥₑᵣₜ, greater principal horizontal stress, σ_{horiz-1}, and lesser principal horizontal stress, σ_{horiz-2}.

“Poisson Ratio,” or “υ,” means, for a substantially elastic body of material when placed under a substantially uniaxial stress, the ratio of the strain normal to the uniaxial stress to the strain parallel to the uniaxial stress.

“Elastic stress to-strain modulus” means a ratio of stress applied to a body versus the strain produced. Elastic stress-to-strain moduli include, without limitation, Young's modulus, (“E”), bulk modulus (“K”), and shear modulus (“G”).

“Young's Modulus” (“E”) means, for a substantially elastic body of material when placed under a substantially uniaxial stress less than the material's yield strength, whether a tension or compression stress, the ratio of the uniaxial stress, acting to change the body's length (parallel to the stress), to the fractional change in the body's length.

“Elastic” means a body of material capable of sustaining deformation and/or distortion without permanent loss of size or shape in response to a stress-inducing force, whether the body's response is linear elastic or non-linear elastic.

“Inelastic” or “Plastic” means that any deformation and/or distortion to a body of material subjected to a stress-inducing force is permanent, i.e. deformation/distortion remains after the force is removed.

“Yield Strength” means the stress value at which deformation resulting from a stress-inducing force becomes permanent. At that stress value, a body of material, which previously exhibited an elastic response, will begin to exhibit a plastic response to the stress-inducing force.

“Subsurface” means beneath the top surface of any mass of land at any elevation or over a range of elevations, whether above, below or at sea level, and/or beneath the floor surface of any mass of water, whether above, below or at sea level.

“Formation” means a subsurface region, regardless of size, comprising an aggregation of subsurface sedimentary, metamorphic and/or igneous matter, whether consolidated or unconsolidated, and other subsurface matter, whether in a solid, semi-solid, liquid and/or gaseous state, related to the geological development of the subsurface region. A formation may contain numerous geologic strata of different ages, textures and mineralogic compositions. A formation can refer to a single set of related geologic strata of a specific rock type, or to a whole set of geologic strata of different rock types that contribute to or are encountered in, for example, without limitation, (i) the creation, generation and/or entrapment of hydrocarbons or minerals and (ii) the execution of processes used to extract hydrocarbons or minerals from the subsurface.

“Design of experiments” means a technique for identifying sampling points for variables or input parameters to be used in constructing a surrogate modeling system. Examples include a classical system and a space-filling method.

“Surrogate model” or “surrogate modeling system” means a mathematical model that seeks to interpolate or extrapolate a solution based on output values previously acquired from empirical observation or mathematical calculations. In some instances herein, the term “surrogate model” may be referred to as a “response surface.”

### Description of Selected Specific Embodiments

In the following description, selected specific embodiments of the present inventions will be described. However, to the extent that the following description is specific to a particular embodiment or a particular use of the present techniques, such is intended to be illustrative only.

The present inventions relate generally to the simulation of subsurface activities associated with hydrocarbon recovery. Such activities may include both the production of fluids from and the injection of fluids into a reservoir. The present inventions also relate to design of experiments techniques for creating a surrogate model for near-wellbore, subsurface analysis. Such analysis may include a determination of well operability limits.

A surrogate model, or as sometimes referred to herein, a “response surface” is a set of equations or algorithms created from data associated with one or more physics-based engineering model simulations. Such computational models or simulations are typically based on a finite element method. However, other methods such as finite volume, finite difference, or other grid-based discretization may be used. In practice, the algorithm or “response surface” is stored in memory and made accessible through software or other computer-based “user tool.” The user tool provides the reservoir engineer or other analyst with access to the detailed physics governing well operability analysis, well producibility analysis or formation injectibility analysis without the analyst having to utilize a detailed reservoir engineering simulation model. This means that the analyst does not have to repeatedly perform a detailed, physics-based engineering model simulation for every possible scenario, but may access previously performed simulations of the detailed, physics based engineering model for other wells in various phases of the reservoir development.

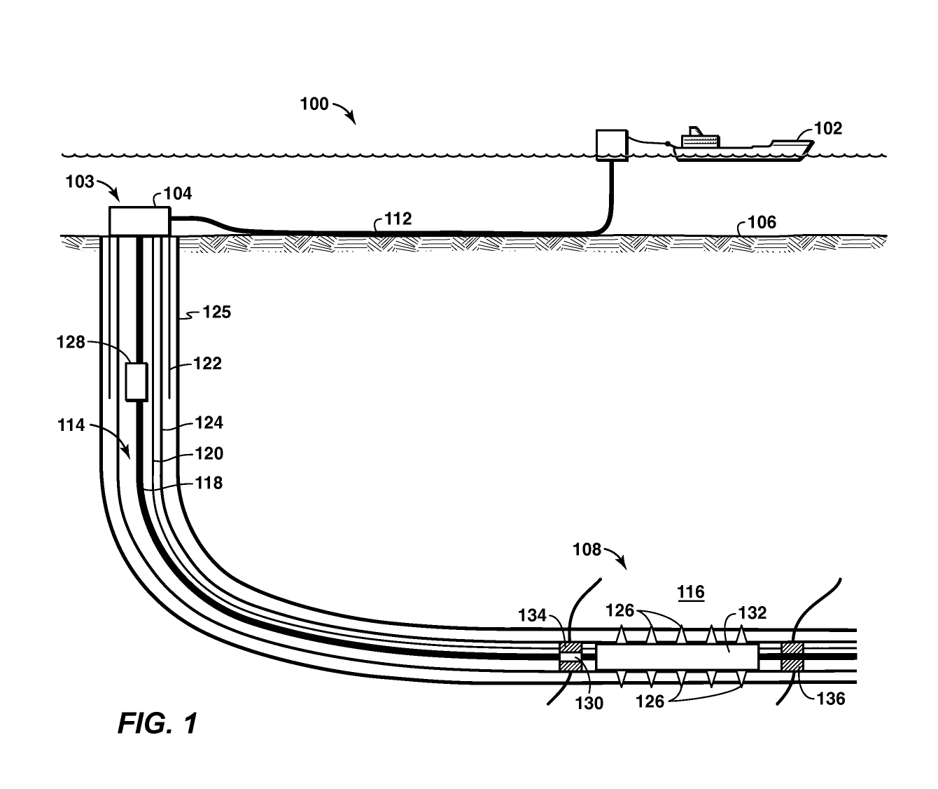

Turning now to the drawings, and referring initially to FIG. 1, an exemplary production system 100 is illustrated. In the production system 100, a floating production facility 102 is coupled to a well 103 having a subsea tree 104 located on the sea floor 106. To access the subsea tree 104, a control umbilical 112 may provide a fluid flow path between the subsea tree 104 and the floating production facility 102 along with a control cable (not shown) for communicating with various devices within the well 103. Through this subsea tree 104, the floating production facility 102 accesses a subsurface formation 108 that includes hydrocarbons, such as oil and gas. However, it should be noted that the offshore production system 100 is illustrated for exemplary purposes and the present techniques may be useful in the production of fluids or the analysis of reservoirs at any location.

To access the subsurface formation 108, the well 103 penetrates the sea floor 106 to form a wellbore 114 that extends to and through at least a portion of the subsurface formation 108. As may be appreciated, the subsurface formation 108 may include various layers of rock that may or may not include hydrocarbons and may be referred to as zones. In this example, the subsurface formation 108 includes a production zone or interval 116. This production zone 116 may include fluids, such as water, oil and/or gas. The subsea tree 104, which is positioned over the wellbore 114 at the sea floor 106, provides an interface between devices within the wellbore 114 and the floating production facility 102. Accordingly, the subsea tree 104 may be coupled to a production tubing string 118 to provide fluid flow paths and a control cable 120 to provide communication paths, which may interface with the control umbilical 112 at the subsea tree 104.

The wellbore 114 may also include various casings 122, 124 to provide support and stability for access to the subsurface formation 108. For example, a surface casing string 122 may be installed from the sea floor 106 to a location beneath the sea floor 106. Within the surface casing string 122, an intermediate or production casing string 124 may be utilized to provide support for walls of the wellbore 114. The production casing string 124 may extend down to a depth near or through the subsurface formation 108. If the production casing string 124 extends to the production zone 116, then perforations 126 may be created through the production casing string 124 to allow fluids to flow into the wellbore 114. Further, the surface and production casing strings 122 and 124 may be cemented into a fixed position by a cement sheath or lining 125 within the wellbore 114 to provide stability for the well 103 and to isolate the subsurface formation 108.

To produce hydrocarbons from the production zone 116, various devices may be utilized to provide flow control and isolation between different portions of the wellbore 114. For instance, a subsurface safety valve 128 may be utilized to block the flow of fluids from the production tubing string 118 in the event of rupture or break in the control cable 120 or control umbilical 112 above the subsurface safety valve 128. Further, the flow control valve 130 may be a valve that regulates the flow of fluid through the wellbore 114 at specific locations. Also, a tool 132 may include a sand screen, flow control valve, gravel packed tool, or other similar well completion device that is utilized to manage the flow of fluids from the production zone 116 through the perforations 126. Finally, packers 134 and 136 may be utilized to isolate specific zones, such as the production zone 116, within the annulus of the wellbore 114.

As noted above, the various phases of well development are typically performed as serial operations that utilize specialized computational models to provide specific information about the well 103. Oftentimes those models are simplified by making general assumptions about certain aspects of the well 103. This, of course, can result in errors that may impact field economics. For example, compaction is a mechanical failure issue that has to be addressed in weak, highly compressible subsurface formations. Typically, compaction is avoided by restricting the flowing bottom hole pressure of the well 103. However, no technical basis supports this practice, which limits the production of hydrocarbons from the well. In addition, faulty assumptions during the well design phases may result in the actual production rates being misinterpreted during the production phase. Accordingly, costly and potentially ineffective remedial actions may be utilized on the well 103 in attempts to stimulate production.

Physics-based simulation models may be employed to account for the parameters that affect well performance or formation injectivity. However, such models are complex, they are time consuming to implement, and they are computationally intensive. Further, new models must generally be developed for each particular well or near-wellbore area of interest. Because these complicated models are directed to a specific application, it is not economically practical to conduct different studies to optimize the completion design and/or ensure that all of the wells in a field are producing at full capacity. Typically, a field includes numerous wells that produce hydrocarbons on a daily basis. Likewise, it is not practical to utilize the complicated simulation models to prevent well failures for each well or to analyze injectivity relative to each injection well. In addition, it is unreasonable to utilize the complicated physics-based models during each phase of the development of a well because of the time associated with the analysis or processing of the data. As such, the complicated models leave many wells unevaluated for potential failures and maintained in a non-optimized state.

Beneficially, a user tool and methods are disclosed herein for modeling well performance prediction, evaluation, optimization, and characterization of a well. In addition, and as discussed further below, a method for generating a surrogate model for near-wellbore, subsurface analysis is provided. The user tool and the various methods discussed herein utilize outputs produced from physics-based computational simulations. However, it is not necessary to repeat the physics-based simulations for every well or production scenario or well development phase; instead, a selected number of simulations are run to create a reference database for creating the surrogate model. Different surrogate models, or response surfaces, may be created for different types of problems sought to be solved.

In certain aspects herein, engineering-model-based response surfaces provide physics based well producibility limits or well operability limits. Alternatively, engineering-based computational simulators are used to develop coupled physics technical limits. The well producibility limit along with the well operability limits and the coupled physics limits are used to develop integrated well performance limits, which are discussed below in greater detail. The response surfaces may be utilized to efficiently evaluate a well through each of the different phases of the well's development.

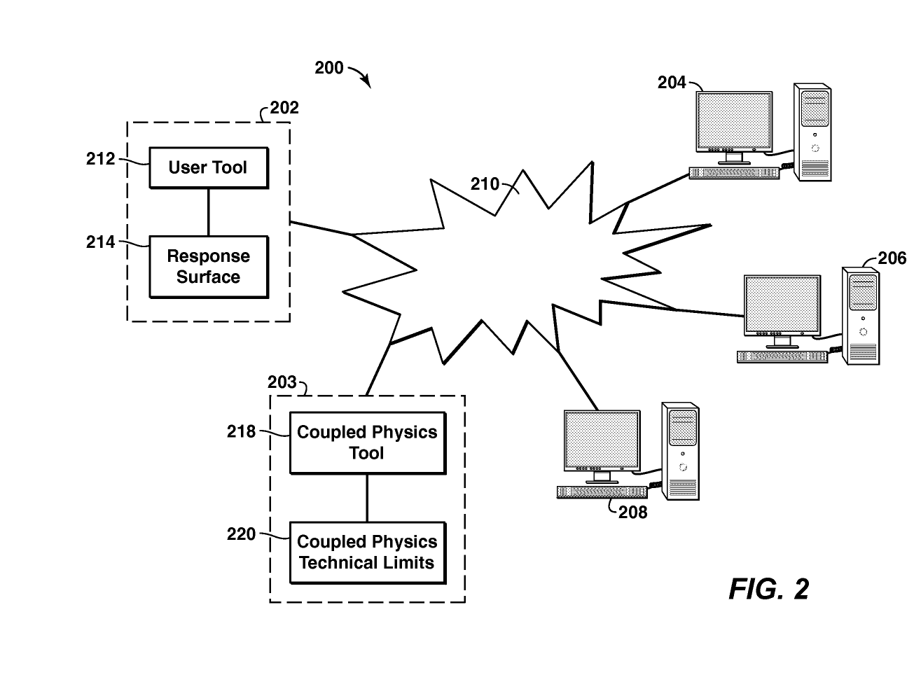

An exemplary embodiment of the user tool is discussed in greater detail in FIG. 2. FIG. 2 presents a modeling system 200 in accordance with certain aspects of the present techniques. In this modeling system 200, a first device 202 and a second device 203 may be coupled to various client devices 204, 206 and 208 via a network 210. The first device 202 and second device 203 may be a computer, a server, a database or other processor-based device, while the other devices 204, 206, 208 may be laptop computers, desktop computers, servers, or other processor-based devices. Each of these devices 202, 203, 204, 206 and 208 may include a monitor, keyboard, mouse and other user interface components for interacting with the analyst.

Because each of the devices 202, 203, 204, 206 and 208 may be located in different geographic locations, such as different offices, buildings, cities, or countries, the network 210 may include different devices (not shown), such as routers, switches, bridges, or cables for example. Also, the network 210 may include one or more local area networks, wide area networks, server area networks, or metropolitan area networks, or combinations of these different types of networks. The connectivity and use of network 210 by the devices 202, 203, 204, 206 and 208 operate through the Internet, an intranet or other system using either a wired or a wireless platform.

In an alternative and more basic arrangement, the system 200 may be implemented without a network 210. In such an arrangement, the first device 202 is loaded onto the second device 203, with the second device 203 residing in one or more of devices 204, 206, 208. It is understood that the user tool and methods disclosed herein are not limited by the architecture of the modeling system 200 shown in FIG. 2, so long as the system has sufficient memory, operating speed and user interface components to operate the appropriate software including a user tool 212.

The first device 202 includes the user tool 212. The user tool 212, which may reside in memory (not shown) within the first device 202, may be an application, for example. This application, which is further described below, may provide computer-based representations of a well completion, such as well 103 of FIG. 1, connected to a petroleum reservoir or a depositional basin, such as subsurface formation 108 of FIG. 1. The user tool 212 may be implemented as a spreadsheet, program, routine, software package, or other computer readable software instructions in an existing program, which may be written in a computer programming language, such as Visual Basic, Fortran, C++, Java and the like. Of course, the memory storing the user tool 212 may be of any conventional type of computer readable storage device used for storing applications, which may include hard disk drives, floppy disks, CD-ROMs and other optical media, magnetic tape, and the like.

The user tool 212 is configured to interact with one or more response surfaces 214. The response surfaces 214 represent surrogate models that have been created as a means of modeling such objects as well operability limits, well producibility limits, and formation injectivity. In the arrangement of FIG. 2, the user tool 212 is based on a common platform to enable analysts to evaluate technical limits at the same time, possibly even simultaneously. The analysts use one of the devices 204, 206, 208 to operate the user tool 212 and to obtain solutions based upon surrogate models. Further, the user tool 212 may be configured to provide graphical outputs that define the technical limit of a well or an operation and allow the analysts to compare various parameters so as to modify technical limits to enhance the production rates without damaging the well. These graphical outputs may be provided in the form of graphics or charts that may be utilized to determine certain limitations or enhanced production capacity for a well. In particular, these technical limits may include the well operability limits and well producibility limits, discussed below in greater detail.

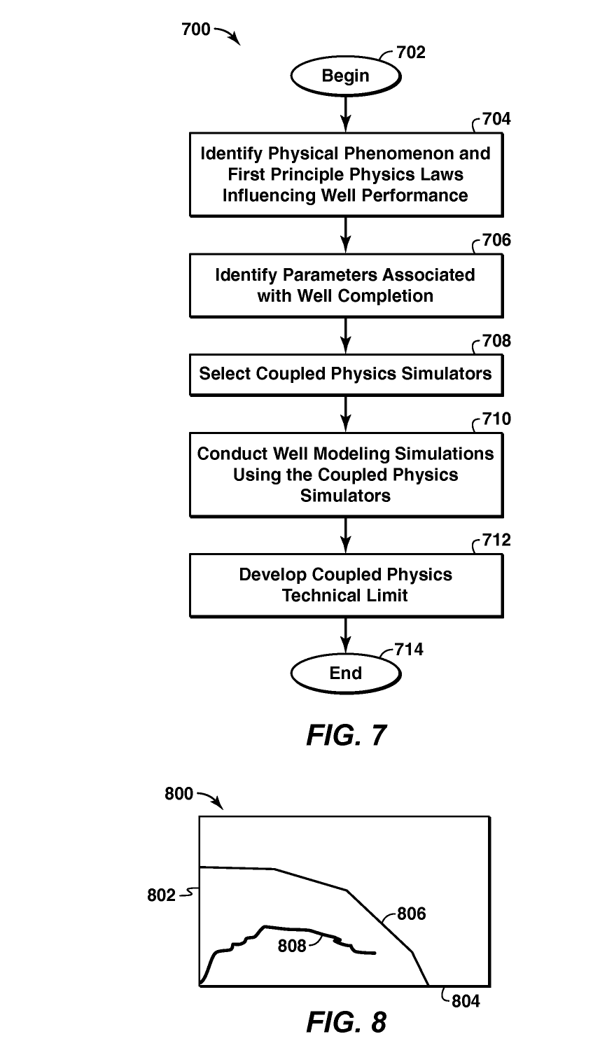

The second device 203 includes a coupled physics tool 218 that is configured to integrate various engineering models together for a well completion. The coupled physics tool 218, which may reside in memory (not shown) within the second device 203, may be an application, for example. This application, which is further described below in FIGS. 7 and 8, may provide computer-based representations of a well completion, such as well 103 of FIG. 1, connected to a petroleum reservoir or a depositional basin, such as subsurface formation 108 of FIG. 1. The coupled physics tool 218 may be implemented as a program, routine, software package, or additional computer readable software instructions in an existing program, which may be written in a computer programming language, such as Visual Basic, Fortran, C++, Java and the like. Of course, the memory storing the coupled physics tool 218 may be of any conventional type of computer readable storage device used for storing applications, which may include hard disk drives, floppy disks, CD-ROMs and other optical media, magnetic tape, and the like.

Associated with the coupled physics tool 218, various engineering models, which are based on complex, coupled-physics models, may be utilized to generate coupled physics technical limits 220 for various failure modes. The coupled physics technical limits 220 may include various algorithms and equations that define the technical limits for the well for various failure modes that are based on the physics for the well completion and near well completion. Similar to the user tool 212, the coupled physics technical limits 220 may be accessed by other devices, such as devices 204, 206 and 208, and may be configured to provide graphical outputs that define the selected technical limit. A more detailed discussion of the coupled physics limits or coupled physics technical limits is discussed in FIGS. 7 and 8 below.

Beneficially, the operation of the well may be enhanced by technical limits derived from utilizing the user tool 212 which is based on response surface 214 developed using computer-implemented computational engineering models or simulations based on either finite difference, 3D geomechanical finite-element, finite element, finite volume, or another point or grid/cell based numerical discretization method used to solve partial differential equations. Unlike these complicated engineering models, the user tool 212 is based on response surfaces 214 that are derived from the outputs of engineering models. The user tool 212 based on response surfaces 214 may be utilized for a variety of different wells, that is, the response surfaces 214 may represent detailed engineering models without requiring a tremendous amount of computing power and skilled expertise to operate, configure, and evaluate the software packages Such software packages include, for example, ABAQUS™, Fluent™, Excel™, and Matlab™

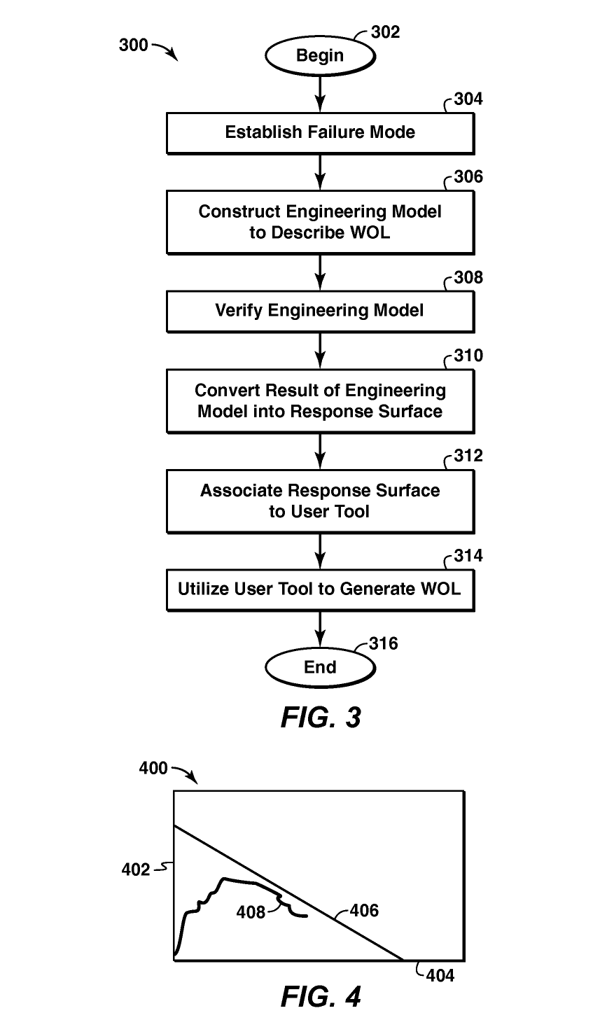

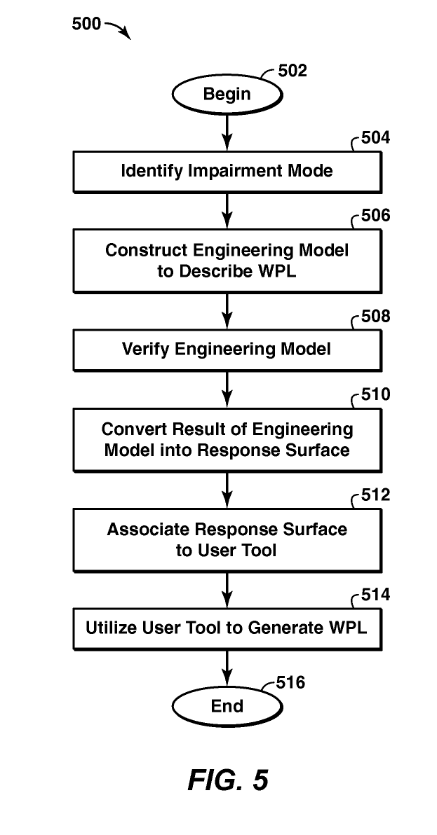

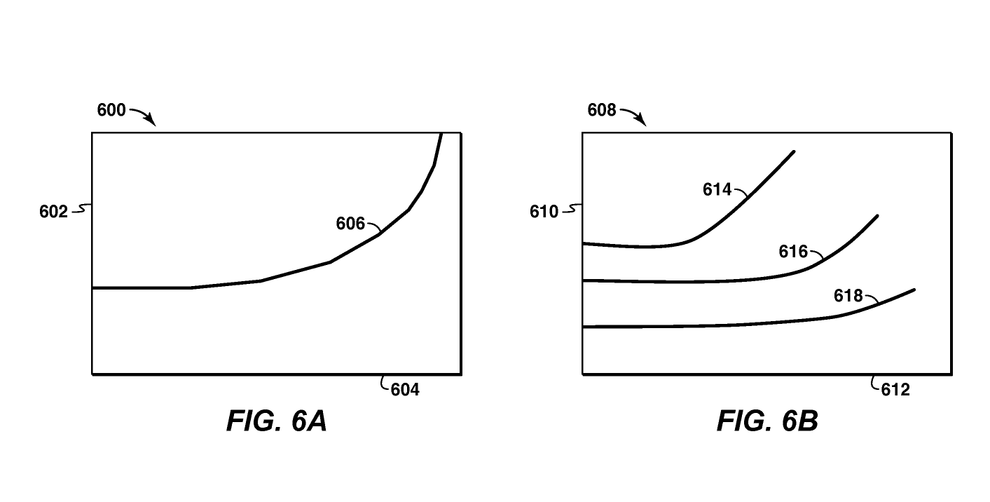

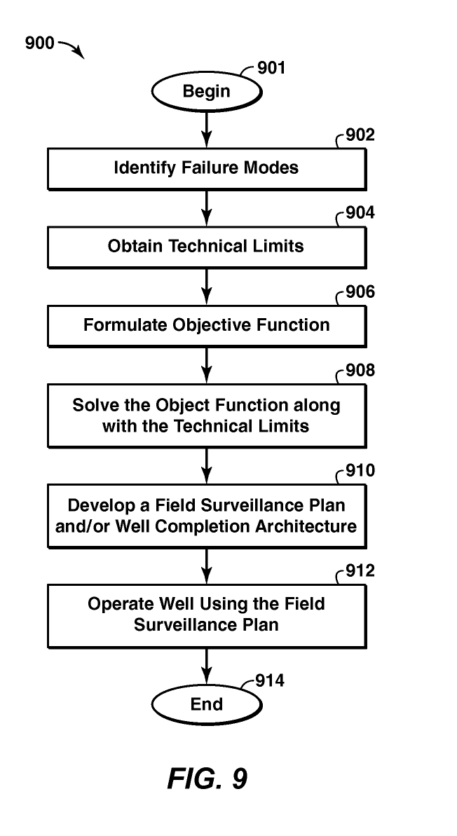

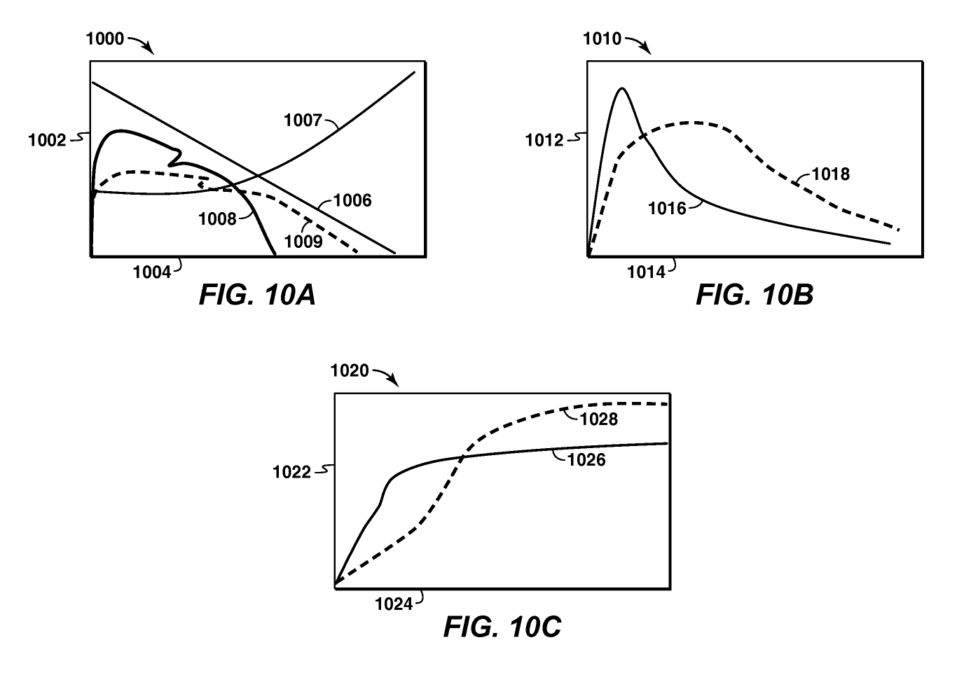

The user tool 212 may be applied to a variety of wells to assess the risk of mechanical well integrity or operability failure, potential for well producibility or flow capacity limit, optimize well performance using the well operability limits along with the well producibility limits, and/or the coupled physics technical limit that addresses other physical phenomenon not addressed by the operability and producibility limits, as discussed below. As an example, a risk assessment may be conducted during the concept selection phase to aid in well completion selection decisions, well planning phase to aid in well and completion designs, and production phase to prevent failures and increase the production rates based on the technical limits. That is, the response surfaces 214 of the user tool 212 may be applied to various phases of the well's development because the user may adjust a wide range of input parameters for a given well without the time and expense of engineering models or the errors associated with limiting assumptions within simplified models. Accordingly, the user tool 212 may be utilized to provide well technical limits relating to well operability as discussed in association with FIGS. 3 and 4, or well producibility limits as discussed in association with FIGS. 5 and 6. Further, the user tool 212 may employ well operability limits and/or well producibility limits and/or coupled physics limits as discussed in association with FIGS. 7 and 8, for the optimization of various technical limits or well operating parameters as discussed in association with FIGS. 9 and 10.

As one embodiment, the user tool 212 may be utilized to provide response surfaces 214 that are directed to determining the well operability limits. The well operability limits relate to the mechanical integrity limits of a well before a mechanical failure event occurs. The mechanical failure may be an event that renders the well unusable for its intended purpose. For example, the mechanical failure of the well 103 of FIG. 1 may result from compaction, erosion, sand production, collapse, buckling, parting, shearing, bending, leaking, or other similar mechanical problems during production or injection operations of a well. Typically, these mechanical failures result in costly workovers, sidetracking of the well or redrilling operations utilized to capture the hydrocarbon reserves in the subsurface formation 108 of FIG. 1. These post-failure solutions are costly and time-consuming methods that reactively address the mechanical failure. However, with the user tool 212, potential mechanical well failure issues may be identified during the different phases to not only prevent failures, but operate the well in an efficient manner within its technical limit.

FIG. 3 is an exemplary flow chart of the generation and use of well operability limits with the user tool 212 of FIG. 2. This flow chart, which is referred to by reference numeral 300, may be best understood by concurrently viewing FIGS. 1 and 2. In this flow chart 300, response surfaces 214 may be developed and utilized to provide completion limits and guidelines for the conception selection, well planning, economic analysis, completion design, and/or well production phases of the well 103. That is, the present technique may provide a response surface 214 for various mechanical or integrity failure modes from detailed simulations performed and stored on an application, such as the user tool 212, in an efficient manner. Accordingly, the response surface 214, which is based on the coupled-physics, engineering model, provides analysts with algorithms and equations that may be utilized to solve mechanical well integrity problems more efficiently.

The flow chart begins at box 302. At box 304, a failure mode is established. The establishment of the failure mode 304, which is the mechanical failure of the well, includes determining how a specific well is going to fail. For example, a failure mode may be sand production that results from shear failure or tensile failure of the rock. This failure event may result in a loss of production for the well 103.

At box 306, an engineering model for a failure mode is constructed. Stated another way, an engineering model is constructed to describe the well operability limits (“WOL”) of a well. The purpose for constructing the model 306 is to determine the interaction of well components with the subsurface environment. The well components may include pipe strings, cement, sand screens, and gravel. The subsurface environment may include such parameters as:

rock mechanical properties,

flowing bottom hole pressure (FBHP),

drawdown (DD),

depletion (DEP),

production rate (PR),

water-oil ratio (WOR), and

gas-oil ratio (GOR).

If, for example, the failure mode 304 is sand production, the computational engineering model 306 may utilize the rock mechanical properties with a numerical simulation model of the reservoir and well to predict when sand production occurs under various production conditions. Such production conditions may include production rate, drawdown, and/or depletion.

After constructing the computational engineering model 306, the model 306 is preferably verified to establish that the engineering model 306 is valid. This step is shown in box 308. The verification step 308 may include comparing the outputs of the engineering model 306 with actual data from the well 103. Alternatively, or in addition, the step 308 may include comparing solutions or outputs derived from the engineering model 306 to known empirical results from other wells within the field.

Because the engineering model 306 is generally a detailed finite element models that takes a significant amount of time to evaluate, such as multiple hours to multiple days, the engineering model 306 is converted into one or more algorithms or equations referred to herein as the response surface 214. The response surface 214 serves as a surrogate model for solving a complex engineering problem. One or more response surfaces 214 may be created. The step of converting the engineering model 306 into one or more response surfaces 214 is represented at box 310.

In practice, the conversion step 310 is accomplished herein by performing a parametric study on a range of probable input parameters. The selected input parameters have pre-determined values that serve as representative sampling points. The sampling points are used to acquire various output values for an engineering problem. An example of an engineering problem is determining well operability limits.

Output values for the selected sampling points may be acquired in different ways. As noted, a number of engineering model 306 runs may be made using pre-determined values for the sampling points to create the representative output values. In other words, data points may be acquired by actually running a numerical simulator (that is, the engineering model 306) under selected values for the input parameters. The step 310 may alternatively comprise acquiring data from field operations at actual values for at least some of the identified input parameters. In addition, the step 310 may comprise acquiring data from laboratory experiments at pre-determined values for at least some of the identified input parameters. In any of these approaches, the result is that a number of output values are acquired for the selected engineering problem. This process of gathering output values at different input parameter values represents a parametric study.

To help ensure that output values represent an appropriate representation of input parameter values, it is desirable that the sampling points be distributed across a reasonable range of parameter values. This ultimately produces a more accurate algorithm that serves as the response surface 214. Accordingly, the parametric study herein utilizes a numerical design of experiments technique to provide the algorithms for the various engineering scenarios. “Design of experiments” refers to techniques for identifying sampling points to be used in constructing a surrogate model. General examples of design of experiments include classical methods and so-called space-filling methods. Either or both methods may be employed for providing output values within a designated range of values for selected input parameters.

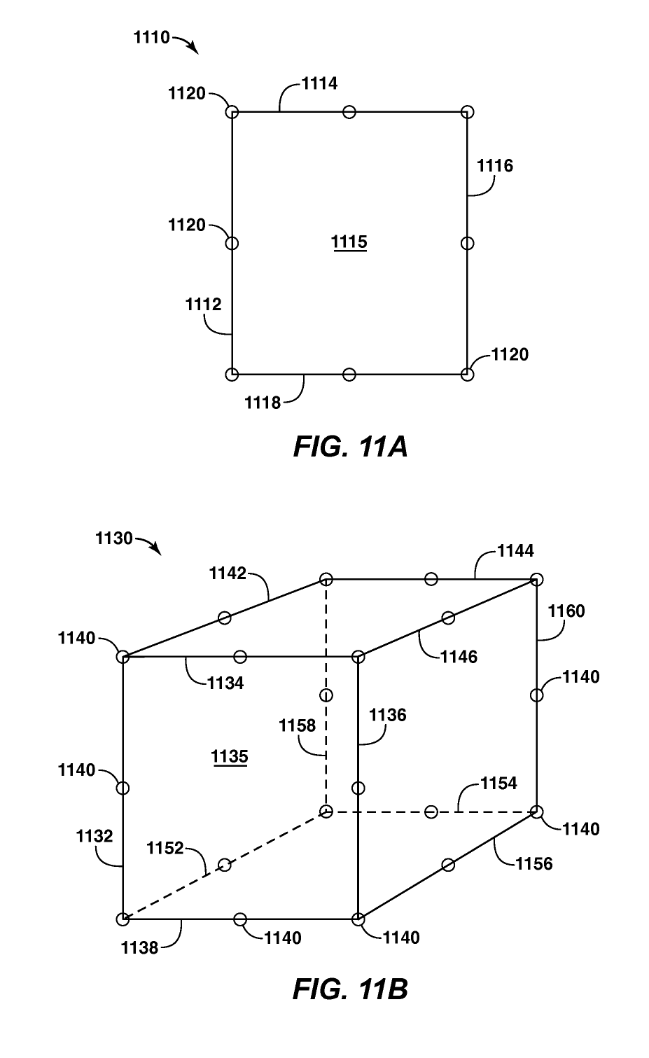

Classical techniques typically involve the placement of sampling points along the edges of a statistical model. This means that design points generated by traditional methods are frequently located on the corners, edges or faces of the application box. This is demonstrated in FIGS. 11A and 11B.

FIG. 11A is a plot 1110 of sampling points 1120 for a two-parameter study generated using a classical design of experiments method. It can be seen that points 1120 are sampled at various peripheral edges 1112, 1114, 1116, 1118. However, an interior 1115 is typically left unfilled. Alternatively, a single sampling will take place at the center but this still leaves only one point at the center compared to eight points along the boundaries.

FIG. 11B is a plot 1130 of sampling points 1140 for a three-parameter study generated using a classical design of experiments method. It can be seen that points 1140 are sampled at various peripheral edges 1132, 1134, 1136, 1138, 1142, 1144, 1146, 1152, 1154, 1156, 1158, 1160. However, an interior 1135 is again typically left unfilled. Alternatively, one or two sampling points may take place internal to the plot 1130, but again this is a small percentage of the overall sampling. Thus, while a full factorial classical space filling technique may test for every possible combination or pre-specified levels, it does so primarily at extreme values of the parameters.

It is noted here that the application box or plot 1110 for the two-parameter study of FIG. 11A is one-dimensional. The application box or plot 1130 for the three-parameter study of FIG. 11B is two-dimensional. Thus, the number of dimensions for the application box is defined by the number of input parameters under study, minus one.

There are several types of classical design of experiments methods. These include a full factorial method, a partial factorial method, a central-composite, and a Box-Behnken method. Each of these is a known experimental design technique for use in surrogate modeling.

Full factorial design and partial factorial design are both “factorial” design of experiments techniques. A factorial experiment is one whose design consists of two or more independent variables, or “factors,” each of which has discrete possible values or “levels.” In addition, the experimental units take on all possible combinations of these levels across all such factors. Such experiments allow the analyst to study the effect of each factor on each response variable. If the number of experiments for a full factorial design is too high to be logistically feasible, a fractional or partial factorial design may be done. In this instance, some of the possible combinations are omitted. However, a large number of runs are still required for accuracy.

The simplest factorial experiment contains two levels for each of two factors. For example, if a reservoir engineer wishes to study the weekly production of two different wells producing at two different drawdowns, then the factorial experiment would consist of four experimental units. These would be well A at drawdown A, well B at drawdown A, well A at drawdown B, and well B at drawdown B. Each combination of a single level selected from every factor is present once.

The above-described experiment is an example of a 2×2 (or 2²) factorial experiment. This is so named because it considers two levels (the base) for each of two factors (the power or superscript). This produces 2²=4 factorial points. Of course, designs can involve many independent variables. For example, the effects of three input variables can be evaluated in eight experimental conditions, that is 2×2×2, or 2³=8. In this instance, the design of experiments is reflected as a cube.

Central composite design is another experimental design useful in surrogate modeling. Central composite design allows the analyst to build a second order (quadratic) model for a response variable without needing to use a complete three-level factorial experiment. After the designed experiment is performed, linear regression is used, sometimes iteratively, to obtain results.

In central composite design, three distinct sets of experimental runs are made. First, a factorial design is made for the factors studied, with each having two levels. Second, a set of center points is provided. These are experimental runs whose values for each factor are the medians of the values used in the factorial portion. Third, a set of axial points is provided. The axial points are experimental runs identical to the center points except for one factor, which will take on values both below and above the median of the two factorial levels, and typically both outside their range. All factors are varied in this way. While the points constructed for this design are more “structural” or more regularly distributed within the box, central composite design is nevertheless considered a classical technique because there is a high percentage of sampling points along the boundaries.

In Box-Behnken designs, each independent variable or “factor” is placed at one of three equally spaced values. At least three levels are needed for this arrangement. The design should be sufficient to fit a quadratic model, that is, one containing squared terms and products of two factors. The ratio of the number of experimental points to the number of coefficients in the quadratic model should be reasonable, such as in the range of 1.5 to 2.6. The estimation variances should more or less depend only on the distance from the center (this is achieved exactly for the designs with 4 and 7 factors), and should not vary too much inside the smallest (hyper)cube containing the experimental points.

Each Box-Behnken design can be thought of as a combination of a two-level (full or fractional) factorial design with an incomplete block design. In each block, a certain number of factors are put through all combinations for the factorial design, while the other factors are kept at the central values. For instance, the Box-Behnken design for three factors involves three blocks, in each of which two factors are varied through the four possible combinations of high and low. It is desirable to include center points as well (in which all factors are at their central values).

Each of the above-described design of experiments methods generates points primarily along the outer edges or faces of an application box. The inventors herein have considered the application of classical methods such as those shown in plots 1110 and 1130 for generating a surrogate model for near-wellbore, subsurface analysis. However, it is also noted that such methods have drawbacks. When design points 1120 or 1140 are placed along the corners, edges or faces of an application box 1110, 1130, some or all of the parameters are assigned with extreme values of their respective ranges. These extreme values may lead to unqualified results for fitting a response surface 214. In addition, missing design points within the volume 1115, 1135 of the application box 1110, 1130 may cause classical experimental design methods to be unbalanced.

In lieu of classical design of experiment methods, that the inventors have also considered using space-filling methods. A preferred example of a space-filling method is the Latin Hypercube Method, or “LHM.” Latin squares give a reasonably random distribution while reducing the number of necessary runs.

LHM relies upon Latin squares defined by rows and columns. In statistical sampling, a Latin square exists if and only if there is only one sample in each row and in each column. Table 1 below shows two squares. The left square is an example of a valid Latin square, while the right square shows an example of an invalid Latin square.

TABLE 1
Examples of Valid and Invalid Latin Squares

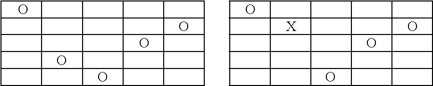

It can be seen that in the Latin square on the left, only one sample resides in each row and in each column. However, the Latin square on the right has a row with two samples. Thus, the Latin square on the left provides for a more even sampling of data.

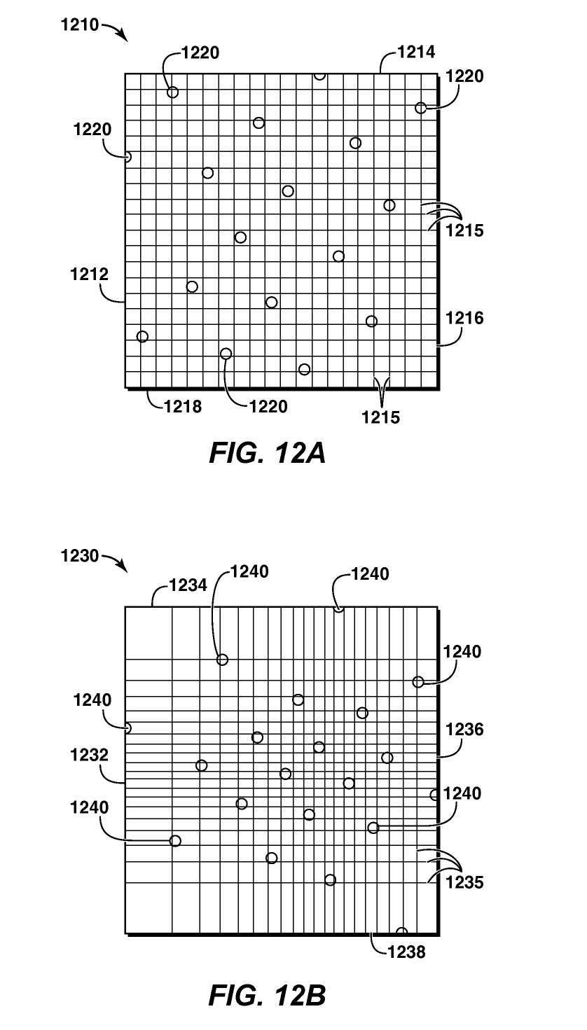

FIG. 12A is a plot 1210 of sampling points 1220 for a two-parameter study generated using a LHM design of experiments method. It can be seen that the plot 1210 includes peripheral edges 1212, 1214, 1216, 1218. However, the sampling points 1220 are sampled along grid lines 1215 that form squares.

When using LHM, grid lines 1215 are associated with the respective parameters. This means that the number of levels for the grids or cells 1215 equals the number of sampling points 1220. As a result of this feature, most sampling points 1220 are located in the interior of the application space 1210. As the number of parameters increases, the corresponding number of grid lines 1215 increases, thereby insuring that the sampling points 1220 remain balanced within the application box 1210.

In LHM, the density distribution of the sampling points may be further controlled by adjusting the spacing of the grid lines. This means that the “size of the levels” is modified to skew the density of sampling points in a particular direction. An example of such density control is demonstrated in FIG. 12B.

FIG. 12B is another plot 1230 of sampling points 1240 for a two-parameter study generated using a Latin Hypercube space-filling method. It can be seen that the plot 1230 includes peripheral edges 1232, 1234, 1236, 1238. The sampling points 1240 are again sampled along grid lines 1235. However, in this instance, the spacing of grid lines 1235 has been adjusted to concentrate the sampling points 1240 more closely towards the center of the plot 1230.

The examples provided in FIGS. 12A and 12B represent Latin squares. These examples are used when there are two parameters under study. When more than two parameters or dimensions are under study, then the squares are stacked on top of one another. In this instance, the squares form “hypercubes.” In other words, a Latin hypercube is a Latin square applied to a multidimensional dataset.

Table 2 shows an example of a valid Latin hypercube. The three tables are intended to be stacked one on top of the other. Note that no two sampling points share an axis when the tables or squares are stacked on top of one another.

TABLE 2
Examples of Valid Latin Squares toForm a Latin Hypercube

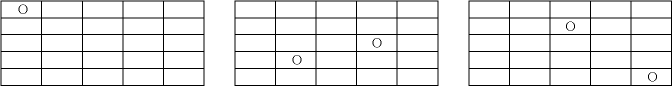

In addition to LHM, other space filling methods may be used for the step 310 of creating one or more response surfaces 214. These include, for example, a sphere packing design method, a uniform design method, and a minimum potential method. These methods constitute algorithms that ensure a dispersing of points within the bounds of an application space, thereby greatly reducing the chance of assigning extreme values of considered factors. This also reduces the number of sampling points required to be tested.

The sphere packing design method seeks to arrange points in a space where the points are non-overlapping. A classical sphere-packing problem is to find an arrangement in which the spheres fill as large a proportion of the space as possible. The proportion of space filled by the spheres is called the density of the arrangement.

The uniform design method seeks to find a design that offers the best uniformity. The measure of uniformity may be star discrepancy, L2 discrepancy, categorical discrepancy, or other forms. A description of these measures may be found in Chapter 3.2 (pages 68-78) of “Design and Modeling for Computer Experiments” (Chapman & Hall/CRC 2006), which is incorporated herein by reference.

The minimum potential method seeks to find a design that minimizes the potential of the system made up of particles located at the sampling points. “Springs” are mathematically connected to those particles. If two particles are too close together, the “springs” push them apart; if the particles are too far apart, the “springs” pull them closer together. By finding the minimum potential of the system, the method will ensure that particles are properly spaced.

For any of these methods, coded variables may be used. This means that a variable such as a log function or a sin function is reassigned a value “x.” An example is x=sin(x).

Each of the above space-filling methods allows the analyst to randomly distribute the test points in such a way that the sampling points neither cluster nor tend towards extreme values. The better the distribution of sampling points used in creating output values from the engineering model 306, the more accurate the converted response surface 214 will be.

Once the output values have been acquired, the surrogate model is constructed. A mathematical algorithm is created that defines the output values. The algorithm, in turn, is used to solve other solutions in the reservoir without having to re-run the complex numerical simulation. This is the response surface 214.

Different mathematical approaches may be taken for defining the algorithm and for generating a surrogate model for the near-wellbore, subsurface analysis herein. The step 310 of constructing a surrogate model may be performed using a polynomial fitting method. Alternatively, the step 310 may employ other fitting techniques. Such other techniques may include a nested surrogates technique, a Kriging method, an artificial neural network method, a cubic spline method or an n-dimensional tessellation method. These techniques are further described below.

A polynomial fitting method generally means using polynomial equations to fit experimental results. In one aspect, the polynomial fitting method employs a coded function to the input parameters. The coding function is preferably a logarithmic function, a trigonometric function, or both.

A “nested surrogates” technique generally means that curve fitting is applied using a fitting function such as:

f(x)=a+b·x+c·x²

in which the terms a, b, and c are not simply fitting constants, but rather functions themselves of another variable, y, “nested” within the main fitting function. These fitting functions may take on forms such as:

a(y)=a₀+a₁·y+a₂·y²

The terms aₒ, a₁, a₂ may also be fitting functions of third variable, z, as follows:

aₒ(z)=a₀₀+a₀₁·z+a₀₂·z²

This process may extend to as many variables as are necessary to properly characterize the physics of the problem at hand. Variables from higher level functions may also be carried into the nested functions to further increase flexibility in curve fitting. For example, instead of the first nested function, a, being only a function of y, it may also be a function of x as follows.

a(x,y)=a₀+a₁y+a₂·y²+a₃·x+a₄·x²+a₅·x·y

The fitting functions are not limited to the polynomial forms shown above, but may take on other functional forms as well. For example, polynomials may exhibit physically unrealistic behavior at extreme values of input parameters, especially if these inputs are outside the range of values from the design of experiments. To overcome this limitation, an alternate form of the fitting function may be used.

f(x)=a·[tan⁻¹(b·x−c)]+d

In this form, the function takes on an “S-shape” with the terms “a” and “d” defining upper and lower bounds. Even if extremely large or small values of x are input to the function, the output will not extend beyond the bounds dictated by “a” and “d.” In this way, “a” and “d” take on physical significance, rather than simply being fitting constants or fitting functions as in a polynomial fit. The terms “b” and “c” also take on physical significance, representing the steepness of the S-shape curve “b” and location of the inflection point along the x-axis “c”.

As with the previous example using polynomials, the terms, “a,” “b,” “c,” and “d” may themselves be fitting functions nested within the main fitting function. They need not be polynomials, but could take on other forms to prevent unrealistic behavior at extreme values of input parameters. A form that's been found useful is.

a(x,y)=a₀+a₁·x^{a2}+a₃·y^{a4}+a₅·x^{a6}·y^{a7}

Again, the nesting may continue to include as many variables as necessary to adequately characterize the physics of the problem.

This “nested surrogates” technique is a useful systematic approach for fitting equations or response surfaces to complex data sets with a large number of variables by combining multiple least squares fits. It is particularly useful when the fitting functions take on physically meaningful forms to ensure realistic behavior over the full range of input parameters.

Next, a Kriging method generally refers to a group of linear least squares estimation algorithms. The Kriging method is used to estimate the value of an unknown real function ƒ at a point x, given the values of the function at some other points. Kriging estimators are said to be linear because the predicted value is a linear combination that may be written as:

$$f ( x ) = {\sum }_{i = 1}^{n} {λ}_{i} f ( {x}_{i} )$$

wherein the weights λᵢ are solutions of a system of linear equations which are obtained by assuming that f is a sample-path of a random process F(x), and that the error of prediction

$$ɛ ( x ) = F ( x ) - {\sum }_{i = 1}^{n} {λ}_{i} F ( {x}_{i} )$$

is to be minimized.

Kriging is oftentimes used as a geostatistical technique for interpolating the value of a random field. An example is the elevation of landscape as a function of its geographical location. In the present application, Kriging is used to interpolate values for a reservoir engineering solution.

An artificial neural network is a non-linear statistical data modeling or decision-making tool. In a neural network model, simple nodes, referred to as “neurons” or “neurodes,” are connected together to form a network of nodes. Its practical use comes with algorithms designed to alter the strength (or weighting) of the connections in the network to produce a desired signal flow. Neural networks can be used to model complex relationships between inputs and outputs or to find patterns in data. Neural networking software is available for such modeling.

Sampling points in an n-parameter system may be perceived to be distributed in an n-dimensional space. An n-dimensional tessellation method may be applied by constructing an n-D simplex which connects data points. Each simplex will typically have a vertex at a data point. Where a proper tessellation method is chosen, each simplex will exclude sampling points inside its domain. When used as surrogate model for a particular combination of input parameters, the simplex in which the inquiry point is located will first be found. The surrogated value will then be interpolated from the existing value located at the vertex of the simplex.

The above-described design of experiments techniques allow an analyst to acquire a selection of data points for constructing a more accurate response surface 214. Such data points include output values from the engineering model or simulator constructed in step 306. Curve-fitting or surface-fitting techniques may then be applied to the data points to create an algorithm that defines the response surface 214. Unless so stated by the claims, the step 310 of creating a response surface 214 is not limited by the surface fitting or curve fitting technique employed. The response surfaces 214 may be further modified by using various assumptions, such as homogeneous rock properties in a reservoir zone, linear well paths through the production intervals, and/or disc shaped reservoirs, for example.

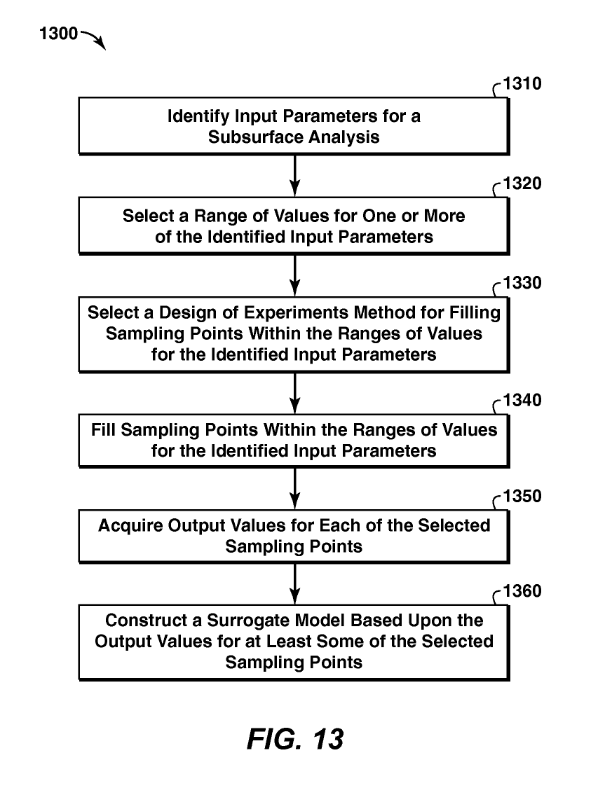

To further expand on the step 310, a flow chart is offered. FIG. 13 is a flow chart demonstrating steps for a method 1300 for generating a surrogate model for near-wellbore, subsurface analysis. Preferably, the subsurface analysis involves a hydrocarbon reservoir.

The method 1300 comprises identifying input parameters for the subsurface analysis. This step is indicated at box 1310. A variety of input parameters may be used depending on the type of engineering analysis being employed. These include:

rock mechanical properties,

well completion (such as cement lining and production casing strings),

flowing bottom hole pressure (FBHP),

drawdown (DD),

depletion (DEP),

production rate (PR),

water-oil ratio (WOR), and

gas-oil ratio (GOR).

The following is a more detailed list of input parameters relating to well completions:

For cased hole wellbores having perforated casing:

wellbore diameter,

perforation length

perforation diameter

perforation phasing

perforation density, and

ratio of vertical permeability to horizontal permeability (kᵥ/kₕ)

For cased hole wellbores having gravel-pack completions:

wellbore diameter,

perforation length

perforation diameter

perforation phasing

perforation density,

perforation tunnel length through casing and cement,

ratio of gravel permeability to rock permeability, and

ratio of vertical permeability to horizontal permeability (kᵥ/kₕ)

For cased hole wellbores completed with perforated gravel, or “frac pack”:

wellbore diameter,

perforation length

perforation phasing

perforation density,

perforation tunnel length through casing and cement,

ratio of gravel permeability to rock permeability,

ratio of vertical permeability to horizontal permeability (kᵥ/kₕ),

fracture length,

fracture width,

ratio of fracture permeability to rock permeability, and

ratio of fracture permeability to gravel permeability.

The above lists are illustrative only and are not intended to be exclusive. Reservoir engineers may understand there to be additional parameters affecting completion design.

After the input parameters are selected 1310, a range of values is determined for one or more of the identified input parameters. This is indicated at box 1320. The range of values need not be the complete range of potential values for the input parameters, but may be a subset representing the most likely values.

The method 1300 also includes selecting a design of experiments method. This is represented at box 1330. The design of experiments method is used for filling sampling points within the ranges of values for the identified input parameters. The design of experiments method may be, for example, one of the classical methods described above. Alternatively, or in addition, the design of experiments method may be one of the space-filling techniques described above. The Latin Hypercube Method is preferred.

The method 1300 also includes filling sampling points within the ranges of values for the identified input parameters. This step is shown at box 1340. In this step, the sampling points are filled based on the design of experiments method selected. As a practical matter, steps 1330 and 1340 are interconnected. In this respect, filling the sampling points 1340 is done based on the design of experiments technique selected in step 1330.

The method 1300 further includes acquiring output values for each of the selected sampling points 1310. This step is provided at box 1350. The step of acquiring output values for each of the selected sampling points 1350 may be done in different ways. For example, the step may comprise running a plurality of computer-implemented simulations having predetermined values for the identified input parameters. In other words, some data points may be acquired by actually running numerical or computational models for the input parameters at pre-determined values in accordance with step 306 of FIG. 3. The step 1350 may alternatively comprise acquiring data from field operations at actual values for at least some of the identified input parameters. Alternatively still, the step 1350 may comprise acquiring data from laboratory experiments at pre-determined values for at least some of the identified input parameters.

The method 1300 also includes constructing a surrogate model based upon the output values for at least some of the selected sampling points. This step is provided at box 1360. The surrogate model 1360 is a mathematical equation that represents a simplified model for predicting solutions to a complex reservoir engineering problem. The step of constructing the surrogate model 1360 may be performed in various ways. As noted, the model may be constructed 1360 by using a polynomial fitting method. Other techniques include the “nested surrogates” technique, the Kriging method, the neural network method, the cubic spline method and the n-dimensional tessellation method.

The surrogate model may be employed for a number of purposes. For instance, the surrogate model may be constructed for the analysis of well producibility. In this instance, the input parameters may comprise reservoir rock properties, reservoir fluid properties, in situ reservoir conditions, completion design, well design, and well operating conditions. Alternatively, the surrogate model may be constructed for analysis of well operability. In this instance, the input parameters may represent reservoir rock properties, reservoir fluid properties, in situ reservoir conditions, completion design, well design, and well operating conditions. Alternatively still, the surrogate model may be constructed for analysis of well injectibility. In this instance, the input parameters may include injection fluid properties, reservoir rock properties, reservoir fluid properties, in situ reservoir conditions, completion design, well design, and well operating conditions.

In one aspect, a surrogate model may be created for evaluating completion efficiency. Completion efficiency generally means the producibility of a well under one completion design as compared to the producibility of that well under another completion design. For example, completion efficiency might be determined by simulating the producibility of a well having two perforation wings as opposed to one perforation wing.

Referring again to FIG. 3, at box 312, the algorithms and equations that define the one or more response surfaces 214 are included in the user tool 212. The user tool 212 may be utilized to provide graphical outputs of a technical limit for the analyst. These graphical outputs may compare production or injection information, such as rates and pressures. In this manner, the analyst may evaluate current production or injection rates versus the technical limit indicated from a response surface 214 to adjust certain input parameters to prevent well failure or to improve the performance of the well 103. This evaluation may be performed in a simplified manner because the previously generated response surface 214 may be accessed instead of having to utilize complex engineering models to simulate each of the respective conditions for the well. The analyst may then optionally apply a quantitative risk analysis to the technical limit generated by the response surface 214 to account for the uncertainty of input parameters.

The user tool 212 may be utilized to efficiently apply the previously generated response surface 214 to certain management decisions. This is indicated at box 314. Such management decisions may include economic decisions, well planning, well concept selection, and well operations phases. The process ends at box 316.

As a specific example, the well 103 may be a cased-hole completion that includes various perforations 126. In this type of completion, changes in the pore pressure at the sand face of the subsurface formation 108, which may be based upon the reservoir drawdown and depletion, may increase the stress on the perforations 126 in the rock of the production interval or zone 116. If the effective stresses on the rock in the production zone 116 exceed the shear failure envelope or a rock failure criterion, then sand may be produced through the perforations 126 and into the wellbore 114. Sand production into the wellbore 114 may, in turn, damage equipment such as the production tree 104 and valves 128 and 130. Sand production may also damage separation and processing equipment at the surface within the production facility 102. Accordingly, the shear failure of the rock in the subsurface formation 108 or crossing the rock failure criterion in the engineering model may be identified as the failure mode, as discussed in connection with box 304.

Once the failure mode is identified, the engineering model may be constructed to describe the mechanical well operability limits (WOL), as discussed in connection with box 306. The engineering model construction may include, for example, defining finite element models to simulate well drainage from the production zone 116 through perforations 126 and into the wellbore 114. These three dimensional (3-D) models may include input parameters that represent the reservoir rock in the production interval 116, cement lining 125, and production casing string 124. For instance, the perforations 126 in the production casing string 124 may be modeled as cylindrical holes, and the perforations 126 in the cement lining 125 and reservoir rock may be modeled as truncated cones with a half-sphere at the perforation tip. Symmetry in the model may be based on perforation phasing and shot density.

In this study, boundary conditions are applied to represent reservoir pressure conditions. Then, each model is evaluated at various levels of drawdown to determine the point at which the rock at the perforations 126 exceeds the shear failure envelope or rock failure criterion. Drawdown is modeled as radial Darcy flow from the well drainage radius to the perforations 126. The well drainage area is the area of the subsurface formation 108 that provides fluids to the wellbore 114.

As an example, one or more finite element models may be created by varying the input parameters. These parameters may include:
(1) rock properties (rock unconfined compressive strength (USC), rock friction angle (RFA); elastic or shear modulus, and/or rock Poisson's ratio (RPR);
(2) casing properties, such as pipe grades (e.g. L80, P110, T95, Q125);
(3) cement properties unconfined compressive strength (UCS), friction angle, elastic or shear modulus, Poisson's ratio);
(4) well drainage radius (WDR);
(5) perforation geometry (PG) (perforations entrance diameter (PED), perforations length (PL), and perforations taper angle (PTA);
(6) casing size (casing outer diameter (COD), casing diameter/thickness (D/T) and casing diameter/thickness ratio (CDTR);
(7) cemented annulus size;
(8) perforation phasing; and
(9) perforation shots per foot (PSPF).

While each of these input parameters may be utilized, it may be beneficial to simplify, eliminate, or combine parameters to facilitate the parametric study. This reduction of parameters may be a part of the identification step 1310 discussed above. The reduction is based upon engineering expertise to combine experiments or utilizing an experimental design approach or process to simplify the parametric study. The automation scripts may be used to facilitate model construction, simulation, and simulation data collection to further simplify the parametric study. For this example, casing properties, perforation phasing, and perforation shots per foot are determined to have minimal impact on the resolution and are removed from the parametric study. Accordingly, the parametric study may be conducted on the remaining parameters, which are included in the Table 3 below.

TABLE 3
WOL Parametric Study.

| Model # | RC | RFA | RPR | WDR | PED | PL | PTA | COD | CDTR |
|---|---|---|---|---|---|---|---|---|---|
| 1 | 1 | 1 | 1 | 1 | 1 | 1 | 1 | 1 | 1 |
| 2 | 1 | 2 | 1 | 3 | 2 | 1 | 3 | 2 | 2 |
| 3 | 3 | 2 | 2 | 3 | 1 | 1 | 1 | 3 | 1 |
| 4 | 2 | 3 | 2 | 2 | 1 | 3 | 1 | 3 | 2 |
| 5 | etc. | | | | | | | | |

wherein:
RC is rock unconfined compressive strength,
RFA is rock friction angle,
RPR is elastic or shear modulus, and/or rock Poisson's ratio,
WDR is well drainage radius,
PED is perforations entrance diameter,
PL is perforations length,
PTA is perforations taper angle,
COD is casing outer diameter, and
CDTR is casing diameter/thickness ratio.

In this example, three values or sampling points may be defined for each of the nine input parameters listed above. These sampling points are selected in accordance with step 1340, described above. The sampling points are defined within ranges selected in step 1320.

In Table 3, 19,683 possible combinations or models of sampling points exist as part of the parametric study. Each of the combinations may be evaluated at multiple values of drawdown to develop the individual technical limit states for each model (e.g. drawdown versus depletion). The evaluations represent output values in accordance with step 1350.

In those instances where the output values 1350 are generated as a result of running computer-implemented simulations or computational engineering models from step 306, the output values may be verified. The verification of the output values as discussed in box 308 may involve comparing the individual engineering model results or output values 1350 with actual field data to ensure that the estimates are sufficiently accurate. The actual field data may include sand production at a specific drawdown for the completion.

With the various engineering models 306 being run, the output values 1350 are converted into response surfaces 214. This step is discussed above in boxes 310 and 1360. The resulting response surface equation or equations provide(s) a technical limit or well operability limit, as a function of drawdown.

If the user tool 212 is a computer program that includes a spreadsheet, the response surface 214 and the associated input parameters may be stored within a separate file that is accessible by the program or combined with other response surfaces 214 and parameters in a large database. Regardless, the response surface and parameters may, in one embodiment, be accessed by other analysts via a network, as discussed above. For instance, the user tool 212 may accept user entries from a keyboard to describe the specific parameters in another well. The response surfaces 214, which are embedded in the user tool 212, may calculate the well operability limits from the various entries provided by the individual analyst. The entries are preferably in the range of values selected in step 1320 and studied in the parametric study 1330, 1340 of the engineering model 306.

As result of this process, FIG. 4 illustrates an exemplary chart of the drawdown verses the depletion of a well. In FIG. 4, a chart, which is generally referred to as reference numeral 400, compares the drawdown 402 of a well to the depletion 404 of the well 103. In this example, the response surface 214 may define a technical limit 406, which is well operability limit, generated from the user tool 212. As shown in the chart 400, the technical limit 406 may vary based on the relative values of the drawdown 402 and the depletion 404. The well 103 remains productive or in a non-failure mode as long as the production or injection level 408 is below the technical limit 406. If the production or injection level 408 is above the technical limit 406, then a shear failure of the rock in the subsurface formation 108 is likely to occur. That is, above the technical limit 406, the well 103 may become inoperable or produce sand. Accordingly, the response surface may be utilized to manage reservoir drawdown and depletion based on a technical limit indicated from the response surface.

Beneficially, under the present technique, the different developmental phases of the well 103 may be enhanced by utilizing the user tool 212 to determine the well operability limits and to maintain the well 103 within those limits. That is, the user tool 212 provides users with previously generated response surfaces 214 during each of the development phases of the well 103. Because the response surfaces 214 have been evaluated versus parameters and properties, the user tool 212 provides simulated information for the mechanical integrity or well operability limits without the delays associated with complex models and errors present in simplistic models. Further, the user tool 212 may provide guidelines for operating the well 103 to prevent failure events and enhance production up to well operability limits.

As another benefit, a response surface 214 may be utilized to generate a well injectibility limit. The well injectibility limit defines the technical limit for an injection well in terms of the well's ability to inject a specified rate of fluids or fluids and solids within a specific zone of a subsurface formation. An example of a failure mode that may be addressed by the injectibility limit is the potential for an injection-related fracture propagating out of the zone and thereby resulting in loss of conformance. Another example of a failure mode that can be addressed is the potential for shearing of well casing or tubulars during multi-well interactions resulting from injection operations in closed-spaced well developments. The well injectibility limit response surface may also be utilized as a well inflow performance model in a reservoir simulator to simulate injection wells.

Impairments to the flow capacity and characteristics of a well influence production or injection rates from the well. The impairments may be due to perforation geometry and/or high velocity (i.e., non-Darcy) flow, near-wellbore rock damage, compaction-induced permeability loss, or other similar effects. Because existing models that describe such impairments are oversimplified, the well productivity or injectivity analysis that is provided by these models neglect certain parameters and may provide inaccurate results. Consequently, errors in the prediction and/or assessment of well productivity from other models may adversely impact evaluation of field economics. For example, failure to accurately account for the effects of completion geometry, producing conditions, geomechanical effects, and changes in fluid composition may result in estimation errors for production rates. During the subsequent production phase, the estimation errors may result in misinterpretations of well test data. This, in turn, may lead to costly and potentially ineffective workovers in attempts to stimulate production. In addition to the errors arising from existing models, complex models fail because they are solely directed to a particular situation. As a result, various wells are insufficiently evaluated or ignored because no tools exist to provide response surfaces for these wells in other situations.

Under the present technique, the producibility or injectibility of a well may be enhanced by utilizing the one or more response surfaces 214 in the user tool 212. As discussed above, these response surfaces 214 represent simplified algorithms based on more complex engineering computational models, such as 3D geomechanical finite element models. The user tool 212 enables different analysts to access the previously generated response surfaces 214 for the analysis of different wells in various phases. Analysis includes well location selection, well planning, economic analysis, completion design and/or well production phases. During well surveillance, for example, impairment is often interpreted from measured “skin” values. Yet, the skin values are not a valid indication of a well's actual performance relative to its technical limit. Accordingly, by converting the computational engineering models into response surfaces, other input parameters may be utilized to provide the analyst with graphs and data, offering more valid indications of the technical limit of an individual well.

An illustrative flow chart for determining well producibility limit is provided in FIG. 5. FIG. 5 provides an exemplary flow chart relating to the use of well producibility limits in the user tool 212 of FIG. 2. This flow chart, which is referred to by reference numeral 500, may be best understood by concurrently viewing FIGS. 1, 2 and 3. In this embodiment, response surfaces associated with flow capacity and characteristics may be developed and utilized to provide technical limits and guidelines for the concept selection, well planning, economic analysis, completion design, and/or well production phases of a well. Stated another way, the user tool 212 may provide response surfaces 214 for various well producibility limits based upon detailed simulations previously performed for another well.

The flow chart begins at box 502. At box 504, the impairment mode is identified for the well 103. The identification of the impairment mode includes determining conditions that hinder the flow capacity of fluids to and within the well 103 or injection capacity of fluids and/or solids from the well 103 and into the formation 108. As noted above, impairments are physical mechanisms governing near-wellbore flow or are a failure of the well 103 to flow or inject at its theoretical production or injection rate, respectively. For example, the impairment mode may include perforations acting as flow chokes within the well 103.

At box 506, a computational engineering model for the impairment mode is constructed to model the interaction of well characteristics. These characteristics may include completion components, pipe, fluid, rocks, screens, perforations, and gravel under common producing conditions, flowing bottom hole pressure (FBHP), drawdown, depletion, rate, water/oil ratio (WOR), gas/oil ratio (GOR), or the like. As an example, with the impairment being perforations acting as a flow choke, the engineering model may utilize rock and fluid properties with a numerical simulation model of the reservoir, well, and perforations to predict the amount of impairment under various production conditions, such as rate, drawdown, and/or depletion. Then, the engineering models are verified, as shown in box 508. The verification of the engineering models may be similar to the verification discussed in box 308.

Because the computational engineering models are generally detailed finite element models, as discussed above in connection with box 306, the output values of the engineering models are beneficially converted into response surfaces 214 that represent one or more algorithms or equations, as shown in block 510. Similar to the discussion above regarding block 310, parametric studies are performed to provide the response surfaces from various parameters and properties. Beneficially, the parametric studies capture aspects not accounted for with analytical models normally utilized to replace numerical models. These results from the parametric studies 1330, 1340 are reduced to numerical equations through fitting techniques or statistical software packages to form the response surfaces 214. This is as discussed above in connection with chart 1300. Specific techniques may include a polynomial fitting method the “nested surrogates” technique, the Kriging method, the neural network method, the cubic spline method and the n-dimensional tessellation method discussed above.

At box 512, the algorithms of the response surfaces 214 are included in a user tool 212. As noted above in connection with box 312, the user tool 212 may be utilized to provide graphical outputs of the technical limit for the well producibility limits to the analyst. In this manner, the analyst may evaluate current production or injection versus the technical limit to adjust the rate or determine potential impairments to the well. At box 514, the response surfaces 214 may be utilized to efficiently apply previously generated response surfaces 214 to management decisions. These may include economic decisions, well planning, well concept selection, and/or well production phases. Accordingly, the process ends at box 516.

As a specific example, the well 103 may be a cased-hole completion that includes various perforations 126. In this type of completion, the flow of fluids into the wellbore 114 may be impaired because of the “choke” effect of the perforations 126. If the impairment is severe enough, the well may fail to achieve target rates with the associated drawdown. In this sense, impairment may be synonymous with failure. In such situations, the lower production rates may be accepted, but these lower production rates adversely impact the field economics. Alternatively, the drawdown pressure of the well 103 may be increased to restore the well 103 to the target production rate. However, this approach may not be feasible because of pressure limitations at the production facility 102, drawdown limits for well operability, and other associated limitations. Accordingly, the pressure drop into and through the perforations 126 of the well completion may be identified as the impairment or failure mode for the well 103, as discussed above in box 504.

Once the impairment mode is identified, the engineering model may be constructed to describe the well producibility limit (WPL), as discussed in box 506. The engineering model construction for well producibility limits may include defining engineering computational models such as finite element models, to simulate convergent flow into the wellbore through perforations 126 in the well 103. Similar to the engineering model construction of the well operability limits discussed above, the engineering models may include input parameters that represent the reservoir rock in the production interval 116, cement lining 125 and production casing string 124.

Further, input parameters may again be assigned to the reservoir rock, cement lining 125, and production casing string 124. For example, each engineering model is evaluated at various levels of drawdown to determine the drawdown at which the impairment exceeds a threshold that prevents target production rates from being achieved. From this, multiple finite element models are created for a parametric study by varying the following parameters:
(1) rock permeability;
(2) perforation phasing;
(3) perforation shot density;
(4) perforation length;
(5) perforation diameter;
(6) well drainage radius; and
(7) wellbore diameter.

This example may be simplified by removing the drainage radius and wellbore diameter parameters, which are believed to have a minimal impact on the results of the parametric study. Accordingly, the parametric study is conducted on the remaining parameters, which are included in the Table 4 below.

TABLE 4
WPL Parametric Study.

| Model | Rock Per- | Perforation | Shot | Perforation | Perforation |
|---|---|---|---|---|---|
| # | meability | Phasing | Density | Length | Diameter |
| 1 | 1 | 1 | 1 | 1 | 1 |
| 2 | 1 | 2 | 1 | 3 | 2 |
| 3 | 3 | 2 | 2 | 3 | 1 |
| 4 | 2 | 3 | 2 | 2 | 1 |

In this example, three values or sampling points are defined for each of the five input parameters listed above. These sampling points are selected in accordance with step 1340, described above. The sampling points are defined within ranges selected under step 1320.

In Table 4, 243 possible combinations of sampling points exist, each representing a model. Each of the models is evaluated at multiple values of drawdown to develop the individual limit states for each model (e.g. production rate vs. drawdown). Accordingly, for this example, the well producibility limit (WPL) may be defined by the failure of the well completion to produce at a specified target rate. The evaluations represent output values in accordance with step 1350.

In those instances where the output values 1350 are generated as a result of running computer-implemented simulations or engineering models, the output values 1350 may be verified. The verification of the engineering models, as discussed in box 508, may involve comparing the individual simulation results 1350 with actual field data to ensure that the results 1350 are reasonable. With the various computational engineering models being run, the output values 1350 are converted into response surfaces 214. Again, the response surfaces 214 are created from fitting techniques or statistical software packages that generate an equation or algorithm from the output values 1350 of the engineering runs. The resulting equation provides the operating limit, which may be stored in the user tool 212 as discussed above.

As result of this process, FIGS. 6A and 6B illustrate exemplary charts of a well producibility limit. In FIG. 6A, chart 600 compares the measure of impairment 602 to the drawdown 604 of the well 103. In this example, the response surfaces 214 may define a technical limit 606, which is the well producibility limit, generated from the user tool 212. As shown in the chart 600, the technical limit 606 may vary based on the relative values of the impairment 602 and the drawdown 604. The well 103 remains productive or in non-impairment mode as long as the measured impairment is below the technical limit 606. If the measured impairment is above the technical limit 606, then the “choke” effect of the perforations 126 or other impairment modes may limit production rates. That is, above the technical limit 606, the well 103 may produce less than a target rate and remedial actions may be performed to address the impairment.

In FIG. 6B, chart 608 compares the drawdown 610 with depletion 612 of the well 103. In this example, the technical limit 606 may be set to various values for different well profiles 614, 616 and 618. A well profile may include the completion geometry, reservoir and rock characteristics, fluid properties, and producing conditions, for example. As shown in the chart 608, the well profiles 614 may be perforations packed with gravel, while the well profile 616 may be natural perforations without gravel. Also, the well profile 618 may include fracture stimulation. The well profiles 614, 616 and 618 illustrate the specific “choke” effects of the perforations 126 or other impairment modes based on different geometries, or other characteristics of the well.

Beneficially, as noted above, analysts from any location may access the user tool 212 to create the well producibility limit and determine the amount of impairment expected for particular parameters, such as the perforation design, rock characteristics, fluid properties, and/or producing conditions of a well. The user tool 212 may provide an efficient mechanism because it accesses previously determined response surfaces 214 and provides them during various phases or stages of a well's development. For example, during the concept selection and well planning phase, the user tool 212 may be utilized to review expected performance rates of a variety of well completion designs. Similarly, during the design phase, the user tool 212 may enhance or optimize specific aspects of the well design. Finally, during the production phase, the user tool 212 may be utilized to compare observed impairments with expected impairments to monitor the performance of the well completion.

As a third embodiment of the present techniques, the user tool 212 of FIG. 2 may be utilized to predict, optimize, and evaluate the performance of the well 103 based on computational engineering models that are associated with physics describing flow into or out of the well 103. As noted above, well 103, which may operate in a production or injection mode, may be utilized to produce various fluids, such as oil, gas, water, or steam. Generally, engineering modeling techniques do not account for the complete set of first principle physics governing fluid flows into or out of the wellbore and within a well completion. As a result, engineering models typically employ analytical solutions based on highly simplifying assumptions, such as the wide spread use of superposition principles and linearized constitutive models for describing the physics governing well performance. In particular, these simplifying assumptions may include single phase fluid flow theories, application of simple superposition principles, treating the finite length of the well completion as a “point sink,” single phase pressure diffusion theories in the analysis of well pressure transient data, and use of a single “scalar” parameter to capture the wellbore and near-well pressure drops associated with flows in the wellbore, completion, and near-wellbore regions. The simplified versions of the computational engineering models fail to assist in diagnosing the problems with a well because the diagnostic data obtained from the engineering models is often non-unique and does not serve its intended purpose of identifying the individual root cause problems that affect well performance. Thus, the computational engineering models fail to account for the coupling and scaling of various physical phenomena that concurrently affect well performance.

To compound the problems with the simplified assumptions, engineering models are generally based on a specific area of the well and managed in a sequential manner. That is, engineering models are designed for a specific aspect of the operation of a well such as well design, well performance analysis, and reservoir simulators. By focusing on a specific aspect, traditional computational engineering models again do not consistently account for the various physical phenomena that concurrently influence well performance. For example, completion engineers design the well, production engineers analyze the well, and reservoir engineers simulate well production within their respective isolated frameworks. As a result, each of the engineering models for these different groups consider the other areas as isolated events and limit the physical interactions that govern the operations and flow of fluids into the well. The sequential nature of the design, evaluation, and modeling of a well by the individuals focused on a single aspect does not lend itself to a technique that integrates a physics based approach to solve the problem of well performance.

Accordingly, under the present methods, coupled physics tool 218 of FIG. 2 may be configured to provide a coupled physics limit for a well. The coupled physics limit, which is a technical limit, may be utilized in various phases of the well. The coupled physics limit may include effects of various input parameters such as reservoir rock geology and heterogeneity, rock flow and geomechanical properties, surface facility constraints, well operating conditions, well completion type, coupled physical phenomenon, phase segregation, rock compaction related permeability reduction and deformation of wellbore tubulars, high-rate flow effects, scale precipitation, rock fracturing, sand production, and/or other similar problems. Because each of these factors influences the flow of fluids from the subsurface reservoir rock into and through the well completion for a producing well or through the well completion into the subsurface formation for an injection well, the integration of the physics provides an enhanced well performance modeling tool, which is discussed in greater detail in FIG. 7.

FIG. 7 is an exemplary flow chart of the development of a coupled physics limit in accordance with aspects of the present techniques. In this flow chart, which is referred to by reference numeral 700, a coupled physics limit may be developed and utilized to quantify expected well performance in the planning stage or to design and evaluate various well completion types to achieve desired well performance during field development stage. The coupled physics limit may also be utilized to perform hypothetical studies and Quantitative Risk Analysis (QRA) to quantify uncertainties in expected well performance, to identify root issues for under performance of a well in everyday field surveillance, and/or to optimize individual well operations. In one aspect, the coupled physics limit is one or more technical limits which defines a set of algorithms for various well performance limits based on generalized coupled physics models generated from detailed simulations performed for a well. These simulations may be performed by an application, such as the user tool 212 or coupled physics tool 218 of FIG. 2.

The flow chart 700 begins at box 702. In boxes 704 and 706, the various parameters and first principle physical laws are identified for a specific well. At box 704, the physical phenomenon and first principle physical laws influencing well performance are identified. The first principle physical laws governing well performance include, but are not limited to:
fluid mechanics principles that govern multi-phase fluid flow and pressure drops through reservoir rocks and well completions,
geomechanics principles that govern deformation of near-wellbore rock and accompanying well tubular deformations and rock flow property changes,
thermal mechanics that are associated with the phenomenon of heat conduction and convection within near-well reservoir rock and well completion, and
chemistry that governs the phenomenon behind non-native reservoir fluids (i.e. acids, steam, etc.) reacting with reservoir rock formations, formation of scales and precipitates, for example.

The parameters associated with the well completion, reservoir geology (flow and geomechanical) and fluid (reservoir and non native reservoir) properties are also identified, as shown in box 706. These parameters may include the various parameters, which are discussed above.

With the physical laws and accompanying input parameters identified, the coupled physics limit may be developed as shown in boxes 708 to 714. At box 708, a set of coupled physics simulators may be selected for determining the well performance. The coupled physics simulators may include engineering simulation computer programs that simulate rock fluid flow, rock mechanical deformations, reaction kinetics between non-native fluids and reservoir rock and fluids, rock fracturing, etc. Then, well modeling simulations using the coupled physics simulators may be conducted over a range of well operating conditions, such as drawdown and depletion, well stimulation operations, and parameters identified in box 706. The results from these simulations may be used to characterize the performance of the well, as shown in box 710. At box 712, a coupled physics limit, which is based on the well modeling simulations, may be developed as a function of the desired well operating conditions and the parameters. The coupled physics limit is a technical limit that incorporates the complex and coupled physical phenomenon that affects performance of the well. This coupled physical limit includes a combination of well operating conditions for maintaining a given level of production or injection rate for the well. The process ends at box 714.

Beneficially, the coupled physics limit may be utilized to enhance the performance of the well 103. For instance, integrated well modeling based on the coupled physics simulation provides reliable predictions, evaluations, and/or optimizations of well performance that are useful in design, evaluation, and characterization of the well. The coupled physics limits provide physics-based technical limits that model the well for injection and/or production. For instance, coupled physics limits may be useful in designing well completions, stimulation operations, evaluating well performance based on pressure transient analysis or downhole temperature analysis, combined pressure and temperature data analysis, and/or simulating wells inflow capacity in reservoir simulators using inflow performance models. As a result, the use of coupled physics limits helps to eliminate the errors generated from non-physical free parameters when evaluating or simulating well performance. Finally, the present technique provides reliable coupled physics limits for evaluating well performance, or developing a unique set of diagnostic data to identify root cause problems affecting well performance.

As a specific example, the well 103 may be a fracture—gravel packed well completion that is employed in deepwater Gulf of Mexico fields having reservoirs in sandstone and characterized by weak shear strengths and high compressibility. These rock geomechanical characteristics of the sandstone may cause reservoir rock compaction and an accompanying loss in well flow capacities based on the compaction related reduction in permeability of the sandstone. As such, the physical phenomenon governing the fluid flow into the fracture—gravel packed well completion may include rock compaction, non-Darcy flow conditions, pressure drops in the near-wellbore region associated with gravel sand in the perforations and fracture wings.

Because each of these physical phenomena may occur simultaneously in a coupled manner within the near-wellbore region, a Finite Element Analysis (FEA)-based physical system simulator may be utilized to simulate in a coupled manner the flow of fluids flowing through a compacting porous medium into the fracture—gravel packed well completion. The rock compaction in this coupled FEA simulator may be modeled using common rock constitutive behaviors such as elastic, plastic (i.e., Mohr-Coulomb, Drucker-Prager, Cap Plasticity, etc.) or a visco-elastic-plastic. To account for pressure drops associated with porous media flow resulting from high well flow rates, the pressure gradient is approximated by a non-Darcy pressure gradient versus the flow rate relationship. As a result, a FEA engineering model that is representative of the wellbore (i.e., the casing, tubing, gravel filled annulus, casing and cement perforations), the near-wellbore regions (perforations and fracture wings), and reservoir rock up to the drainage radius is developed. This FEA engineering model employing appropriate rock constitutive model and non-Darcy flow model for pressure drops is used to solve the coupled equations resulting from momentum balance and mass balance governing rock deformation and flow through the porous media, respectively. The boundary conditions employed in the model are the fixed flowing bottom hole pressure in the wellbore and the far-field pressure at the drainage radius. Together, these boundary conditions may be varied to simulate a series of well drawdowns and depletions.

The parameters governing the performance of the well completion may be identified. For example, these parameters may include:
(1) well drawdown (i.e., the difference between the far field pressure and flowing bottom hole pressure);
(2) well depletion (i.e., the reduction in the far field pressure from original reservoir pressure);
(3) wellbore diameter;
(4) screen diameter;
(5) fracture wing length;
(6) fracture width;
(7) perforation size in casing and cement;
(8) perforation phasing;
(9) gravel permeability; and/or
(10) gravel non-Darcy flow coefficient.
   Some of these parameters, such as rock constitutive model parameters and rock flow properties, may be obtained from core testing.

In this example, the parameters (3) through (7) may be fixed at a given level within the FEA model. With these parameters fixed, the FEA model may be utilized to conduct a series of steady-state simulations for changing levels of drawdown and depletion. The results of the coupled FEA model may be used to compute well flow efficiency. In particular, if the FEA model is used to predicted flow stream for a given level of depletion and drawdown, the well flow efficiency may be defined as the ratio of coupled FEA model computed well flow rate to the ideal flow rate. In this instance, the ideal flow rate is defined as the flow into a fully-penetrating vertical well completed as an openhole completion, which has the same wellbore diameter, drawdown, depletion, and rock properties as the fully coupled FEA model. The rock permeability used is the ideal flow rate calculation, which is the same as the fully coupled model because the rock compaction and non-Darcy flow effects are neglected. Accordingly, a series of well completion efficiencies are evaluated for varying level of drawdown and depletion and for a fixed set of parameters (3) through (7). Then, a simplified mathematical curve of well completion efficiencies may be generated for varying levels of drawdown and depletion for the coupled physics limit.

As result of this process, FIG. 8 illustrates an exemplary chart of the drawdown verses the depletion of a well. In FIG. 8, a chart 800 compares the drawdown 802 to the depletion 804 of the well 103. In this example, the coupled physics limit may define a technical limit 806 generated from flow chart 700. As shown in the chart 800, the technical limit 806 may vary based on the relative values of the drawdown 802 to depletion 804. The well 103 remains productive as long as the well drawdown and depletion are constrained within the technical limit 806. The technical limit in this example represents the maximum pressure drawdown and depletion that a well may sustain before the well tubulars experience mechanical integrity problems causing well production failure when producing from a compacting reservoir formation. Alternatively, the technical limit 806 also may represent the maximum level of well drawdown and depletion for a given level of flow impairment caused by reservoir rock compaction-related reduction in rock permeability when producing from a compacting reservoir formation. In another scenario, the coupled physics limit may represent the combined technical limit on well performance for a given flow impairment manifesting from the combined coupled physics of high rate non-Darcy flow occurring in combination with rock compaction-induced permeability reduction.

Regardless of the technical limits, which may include the coupled physics limits, well operability limits, well producibility limits or other technical limits, the performance of the well may be optimized in view of the various technical limits. FIG. 9 is an exemplary flow chart of the optimization of well operating conditions and/or well completion architecture with the user tool 212 of FIG. 2 or in accordance with the coupled physics limits tool 203 of FIG. 2 in accordance with aspects of the present techniques. In this flow chart, which is referred to by reference numeral 900, one or more technical limits may be combined and utilized to develop optimized well operating conditions over the life of a well or optimized well completion architecture to achieve optimized inflow profile along a well completion by completing the well within the well production technical limits. The well optimization process may be conducted during the field development planning stage, or during well design to evaluate various well completion types to achieve desired well performance consistent with technical limits during field development stage. Well completion limits may also be used to identify root issues for under performance of a well in everyday field surveillance and/or to perform hypothetical studies and Quantitative Risk Analysis (QRA) to quantify uncertainties in expected well performance. That is, one of the present techniques may provide optimized well operating conditions over the life of the well or optimized well architecture (i.e., completion hardware) to be employed in well completion, which are based on various failure modes associated with one or more technical limits. Again, this optimization process may be performed by an analyst interacting with an application, such as the user tool 212 of FIG. 2, to optimize integrated well performance.

The flow chart begins at box 901. At boxes 902 and 904, the failure modes are identified and the technical limits are obtained. The failure modes and technical limits may include the failure modes discussed above along with the associated technical limits generated for those failure modes. In particular, the technical limits may include the coupled physics limit, well operability limit, and well producibility limit, as discussed above. At box 906, an objective function may be formulated. The objective function is a mathematical abstraction of a target goal that is to be optimized. For example, the objective function may include optimizing production for a well to develop a production path over the life-cycle of the well that is consistent with the technical limits. Alternatively, the objective function may include optimize of the inflow profile into the well completion based upon various technical limits that govern production from the formation along the length of the completion.

At box 908, an optimization solver may be utilized to solve the optimization problem defined by the objective function along with the optimization constraints as defined by the various technical limits to provide an optimized solution or well performance. The specific situations may include a comparison of the well operability limit and well producibility limit or even the coupled physics limit, which includes multiple failure modes. For example, rock compaction related permeability loss, which leads to productivity impairment, may occur rapidly if pore collapse of the reservoir rock occurs. While enhancing production rate is beneficial, flowing the well at rates that cause pore collapse may permanently damage the well and limit future production rates and recoveries. Accordingly, additional drawdown may be utilized to maintain production rate, which may be limited by the well operability limit that defines the mechanical failure limit for the well. Thus, the optimized solution may be the well drawdown and depletion over a well's life-cycle that simultaneously reduces well producibility risks due to flow impairment effects as a result of compaction related permeability loss and the well operability risks due to rock compaction, while maximizing initial rates and total recovery from the well.

In another optimization example, technical limits may be developed for inflow along the length of a completion from the surrounding rock formations. An objective function may be formulated to optimize the inflow profile for a given of amount of total production for a well. Also, an optimization solver may be utilized to solve the optimization problem defined by this objective function along with the optimization constraints as defined by the various technical limits. This optimization solver may provide an optimized solution that is the optimized inflow profile consistent with desired well performance technical limits and target well production rates.

Based on the solutions from the optimization solver, a field surveillance plan may be developed for the field. This is shown in box 910 of FIG. 9. The field surveillance plan may follow the optimization solution and technical limit constraints for the production of hydrocarbons in an efficient and enhanced manner. Alternatively, well completion architecture, i.e., completion type, hardware, and inflow control devices, may be designed and installed within the well to manage well inflow in accordance with technical limits governing inflow from various formations into the well. Then, at box 912, the well may be utilized to produce hydrocarbons in a manner that follows the surveillance plan to maintain operation within the technical limits. The process then ends at box 914.

Beneficially, by optimizing the well performance, lost opportunities in the production of hydrocarbons or injection of fluids and/or solids may be reduced. Also, the operation of the well may be adjusted to prevent undesirable events and enhance the economics of a well over its life cycle.

As a specific example, the well 103 may be a cased-hole completion, which is a continuation of the example discussed above with reference to the processes of FIGS. 3 and 5. As previously discussed, the well operability limits and well producibility limits may be obtained from the processes discussed in connection with FIGS. 3 through 6B or a coupled physics limit may be obtained as discussed in connection with FIGS. 7 and 8.

Regardless of the nature of the engineering problem, the technical limits are accessed for use in defining optimization constraints. Further, any desired objective function from well/field economics perspective may be employed. The objective function may include maximizing the well production rate, or optimizing well inflow profile, etc. To optimize the well production rate, the well operability limit and well producibility limit may be simultaneously employed as constraints to develop optimal well drawdown and depletion history over the well's life cycle. Well operating conditions developed in this manner may systematically manage the risk of well mechanical integrity failures, while reducing the potential impact of various flow impairment modes on well flow capacity. Alternatively, to optimize the inflow profile into the well completion, the well operability limit and well producibility limit for each formation layer as intersected by the well completion may be simultaneously employed as constraints to develop the optimal inflow profile along the length of the completion over a well's life cycle. This optimal inflow profile is used to develop well completion architecture, i.e., well completion type, hardware, and inflow control devices that enable production or injection using the optimized flow conditions.

With the optimized solution to the objective function and the technical limits, a field surveillance plan is developed. The field surveillance may include monitoring of data such as measured surface pressures or the downhole flowing bottom hole pressures, estimates of static shut-in bottom hole pressures, or any other surface or downhole physical data measurements, such as temperature, pressures, individual fluid phase rates, flow rates, etc. These measurements may be obtained from surface or bottom hole pressure gauges, such as distributed temperature fiber optic cables, single point temperature gauges, flow meters, and/or any other real time surface or downhole physical data measurement device that may be utilized to determine the drawdown, depletion, and production rates from each formation layers in the well. Accordingly, the field surveillance plan may include instruments, such as, but not limited to, bottom hole pressure gauges, which are installed permanently downhole or run over a wireline. Also, fiberoptic temperature measurements and other devices may be distributed over the length of the well completion to transmit the real time data measurements to a central computing server for use by engineer to adjust well production operating conditions as per the field surveillance plan. That is, the field surveillance plan may indicate that field engineers or personnel should review well drawdown and depletion or other well producing conditions on a daily basis against a set target level to maintain the optimized well's performance.

FIGS. 10A through 10C illustrate exemplary charts associated with the optimization of the well 103 of FIG. 1, in certain embodiments. In particular, FIG. 10A compares the well operability limit with the well producibility limit of a well for well drawdown 1002 versus well depletion 1004 in accordance with certain of the present techniques. In FIG. 10A, chart 1000 compares well operability limit 1006, as discussed in FIG. 4, with the well producibility limit 1007 of FIG. 6A. In this example, a non-optimized or typical production path 1008 and an optimized integrated well performance (“IWP”) production path 1009 are provided. The non-optimized production path 1008 may enhance the day-to-day production based on a single limit state, such as the well operability limit, while the IWP production path 1009 may be an optimized production path that is based on the solution to the optimization problem using the objective function and the technical limits discussed above. The immediate benefits of the IWP production path 1009 over the non-optimized production path 1008 are not immediately evident by looking at the drawdown versus the depletion alone.

In FIG. 10B, a chart, which is generally referred to as reference numeral 1010, compares the production rate 1012 with time 1014 for the production paths. In this example, the non-optimized production path 1016, which is associated with the production path 1008, and the IWP production path 1018, which is associated with the production path 1009, are represented by the production rate of the well over a period of operation for each production path. With the non-optimized production path 1016, the production rate is initially higher, but drops below the IWP production path 1018 over time. As a result, the IWP production path 1018 presents a longer plateau time and is economically advantageous.

In FIG. 10C, chart 1020 compares the total barrels of production 1022 with time 1024 for the production paths. In this example, the non-optimized production path 1026, which is associated with the production path 1008, and the IWP production path 1028, which is associated with the production path 1009, are represented by the total barrels produced from the well over a period of operation for each production path. With the non-optimized production path 1026, the total barrels is again initially higher than the IWP production path 1028, but the IWP production path 1028 produces more than the non-optimized production path 1026 over the time period. As a result, more hydrocarbons are produced over the same time interval as the non-optimized production path 1026. This, in turn, results in the capture of more of the reserve for the IWP production path.

Alternatively, the optimization may use the coupled physics limit along with the objective function to optimize well performance. For example, because economics of most of the deepwater well completions are sensitive to the initial plateau well production rates and length of the plateau time, the objective function may be maximizing the well production rate. Accordingly, a standard reservoir simulator may be used to develop a single well simulation model for the subject well whose performance is to be optimized (i.e. maximize the well production rate). The reservoir simulation model may rely on volumetric grid/cell discretization methods, which are based on the geologic model of the reservoir accessed by the well. The volumetric grid/cell discretization methods may be Finite Difference, Finite Volume, or Finite Element based methods, or any other numerical method used for solving partial difference equations.

The reservoir simulation model is used to predict the well production rate versus time for a given set of well operating conditions, such as drawdown and depletion. At a given level of drawdown and depletion, the well performance in the simulation model is constrained by the coupled physics limit developed in coupled physics process 700. Additional constraints on well performance, such as an upper limit on the gas-oil-ratios (GOR), water-oil-ratios (WOR), and the like, may also be employed as constraints in predicting and optimizing well performance. An optimization solver may be employed to solve the above optimization problem for computing the time history of well drawdown and depletion that maximizes the plateau well production rate. Then, a field surveillance plan may be developed and utilized, as discussed above.

Another instance in which response surface equations may be generated is in the context of openhole, elastic-plastic shear failure prediction. The response surface equation for shear failure near an openhole completion is assumed to be of the following form:

Shear Failure Indicator=F(ucs, β, E, υ₁, σ₁, σ₂, σ₃, λ, θ, ρᵢ, DD, Dep)

wherein:
ucs is the unconfined compressive strength (psi),
β is the DP friction angle (degrees),
E is the elastic modulus,
υ₁ is Poisson's ration,
σ₁ is the maximum principal in situ stress (psi),
σ₂ is the medium principal in situ stress (psi),
σ₃ is the minimum principal in situ stress (psi),
λ is the angle between σ₂ and the well projection in the σ₂-σ₃ plane (degrees),
θ is the angle between the well and σ₁ direction (degrees),
ρᵢ is the initial pore pressure (psi),
DD is the drawdown (psi), and
Dep is depletion (psi).

The above list includes 12 input parameters. Of these parameters, maximum principal stress may be non-dimensionalized. Non-dimensionalization involves dividing certain parameters by a common denominator in order to convert the parameter into a unitless function. For example, the unconfined compressive strength (“ucs”) is non-dimensionalized by dividing the maximum principle effective in situ stress.

After non-dimensionalization, nine factors will be left. If a full factorial design is used, a three level design may result in 19,683 test points. For all of these points, the factor of compressive strength “ucs” is taken to be the lowest, middle, or largest value of its range. However material with “ucs” being the lowest value may be too soft for the finite element analysis to converge, while ucs being the largest value may be too strong for plastic deformation to occur. Results generated by both of these two possible scenarios are not qualified for fitting the response surface equation for elastic-plastic shear failure prediction. This will make ⅔ of all test points questionable and leave the rest of test points unbalanced.

One way to minimize this is to increase the number of sampling points in each considered input parameter. This would be in accordance with classical design of experiments methods. However this will result in a large number of sampling points and corresponding output values. Therefore, the use of space-filling techniques as described above are preferred. This will help achieve a tractable problem size while maintaining accuracy.

As an example of using the proposed approach, 120 sampling points were generated within an application box using LHM. The “ucs” input parameter as well as all other input parameters thus had 120 levels. Even though only 3.3% of the runs did not have plastic deformation and 17.5% of the runs failed to converge, the majority, or 79.2% of runs, generated qualifying results for fitting a response surface equation.

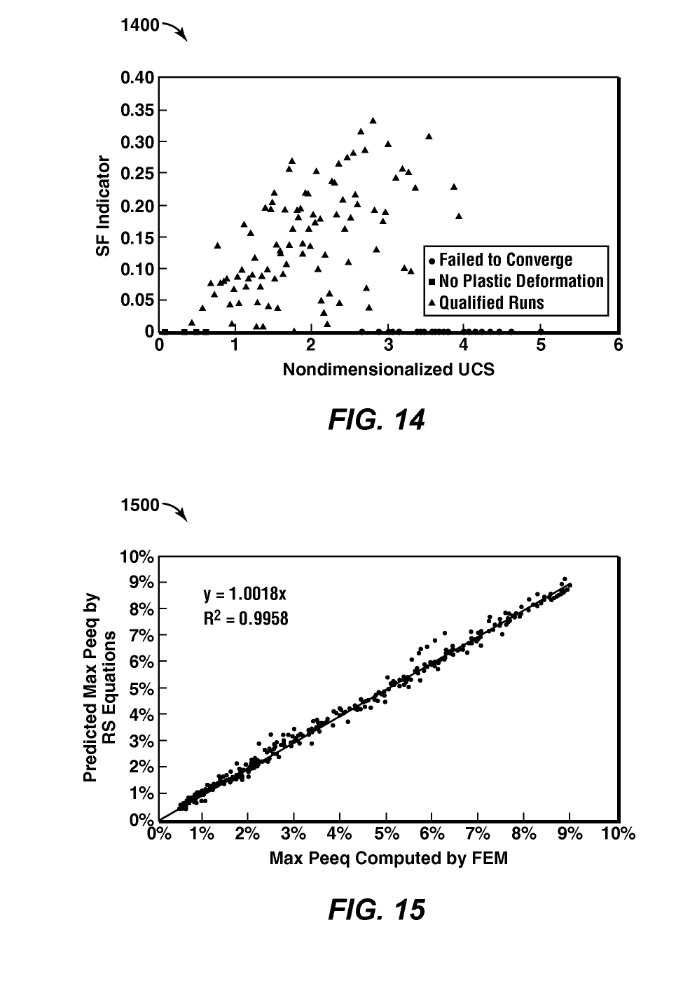

FIG. 14 is a Cartesian coordinate charting a shear failure indicator against an unconfined compressive strength (“UCS”). The shear failure indicator is on the “y” axis, while the “UCS” is on the “x” axis. The unconfined compressive strength is non-dimensionalized by dividing it by the maximum principle effective in situ stress.

FIG. 14 shows the location of certain points, indicated as squares, where no plastic deformation occurred. These points are located along the “x” axis at y=0, and show a low relative UCS value. FIG. 14 also shows the location of certain points, indicated as diamonds, where the points failed to converge. These are unqualified test points that also reside along the “x” axis at y=0. Finally, FIG. 14 also shows the location of qualified runs. Qualifying runs produce a non-zero result.

To verify the response surface equations generated using the LHM sampling approach, the shear failure indicator outputs computed by a response surface equation were compared with those computed by an individual finite element method. This was done for 640 cases. This comparison is illustrated in FIG. 15.

FIG. 15 provides another Cartesian Coordinate. Here, a predicted shear failure indicator using a response surface methodology is compared with the predicted shear failure indicator computed through finite element method. The selected indicator is predicted maximum equivalent plastic strain, or “P_{eeq}.” 640 test cases were compared. In FIG. 15, values for the shear failure predicted using the response surface equation, or surrogate model, are shown on the “y” axis, while the shear failure predicted using the finite element method are shown on the “x” axis. It can be seen that a good correlation of results is observed. This indicates the effectiveness of the proposed space-filling approach for generating response surface equations.

While it will be apparent that the invention herein described is well calculated to achieve the benefits and advantages set forth above, it will be appreciated that the invention is susceptible to modification, variation and change without departing from the spirit thereof.

1. A method for generating a surrogate model for subsurface analysis, comprising:
identifying input parameters for the subsurface analysis;
selecting a range of values for each of the identified input parameters;
selecting a design of experiments method for filling sampling points within the ranges of values for the identified input parameters;
filling sampling points within the ranges of values for the identified input parameters;
acquiring output values for a plurality of the selected sampling points from the selected design of experiments method; and
constructing a surrogate model based upon the output values for at least some of the selected sampling points.

2. The method of claim 1, wherein the subsurface analysis relates to a subsurface region that comprises at least one hydrocarbon-bearing formation.

3. The method of claim 1, wherein the design of experiments method is a classical method.

4. The method of claim 3, wherein the classical method is full factorial design, partial factorial design, central-composite design, Box-Behnken design, or combinations thereof.

5. The method of claim 1, wherein the design of experiments method is a space-filling technique.

6. The method of claim 5, wherein the space-filling technique is a Latin Hypercube, method, a sphere packing design method, a minimum potential method, a uniform design method, or combinations thereof.

7. The method of claim 2, wherein:
the surrogate model is for analysis of well producibility; and
the input parameters comprise reservoir rock properties, reservoir fluid properties, in situ reservoir conditions, completion design, well design, well operating conditions, or combinations thereof.

8. The method of claim 7, wherein reservoir rock properties comprise Poisson's ratio, the modulus of elasticity, shear modulus, Lame' constant, rock strength compressibility, or combinations thereof.

9. The method of claim 7, wherein reservoir fluid properties comprise viscosity, composition, compressibility, or combinations thereof.

10. The method of claim 7, wherein in situ reservoir conditions comprise temperature, pore pressure, porosity, permeability, or combinations thereof.

11. The method of claim 7, wherein completion design comprises completion type, perforation length, perforation diameter, perforation density, perforation phasing, gravel-pack permeability, or combinations thereof.

12. The method of claim 7, wherein well design comprises well angle, casing diameter, wellbore diameter, or combinations thereof.

13. The method of claim 7, wherein the well operating conditions comprise production rate.

14. The method of claim 2, wherein:
the surrogate model is for analysis of well operability; and
the input parameters comprise reservoir rock properties, reservoir fluid properties, in situ reservoir conditions, completion design, well design, well operating conditions, or combinations thereof.

15. The method of claim 2, wherein:
the surrogate model is for analysis of well injectibility; and
the input parameters comprise injected fluid properties, reservoir rock properties, reservoir fluid properties, in situ reservoir conditions, completion design, well design, well operating conditions, or combinations thereof.

16. The method of claim 15, wherein the well operating conditions comprise injection rate.

17. The method of claim 1, wherein the step of acquiring output values for each of the plurality of the selected sampling points comprises running a plurality of computer-implemented computational engineering models having predetermined values for at least some of the identified input parameters.

18. The method of claim 17, wherein the computer-implemented computational engineering models are based on a finite difference method, a finite element method, a finite volume method, a grid-based discretization method, or combinations thereof.

19. The method of claim 1, wherein the step of acquiring output values for each of the selected sampling points comprises acquiring data from field operations at actual values for at least some of the identified input parameters.

20. The method of claim 1, wherein the step of acquiring output values for each of the selected sampling points comprises acquiring data from laboratory experiments at known values for at least some of the identified input parameters.

21. The method of claim 2, wherein the step of constructing a surrogate model is performed using a polynomial fitting method, a nested surrogates technique, a Kriging method, a neural network method, a cubic spline method, an n-dimensional tessellation method, or combinations thereof.

22. The method of claim 21, wherein the polynomial fitting method employs a coded function to the input parameters.

23. The method of claim 22, wherein the coding function is a logarithmic function, a trigonometric function, or both.

24. A method associated with the production of hydrocarbons, comprising:
identifying input parameters for operability of a well that penetrates at least one hydrocarbon-bearing formation;
selecting a range of values for each of the identified input parameters;
selecting a design of experiments method for filling sampling points within the ranges of values for the identified input parameters;
filling sampling points within the ranges of values for the identified input parameters;
constructing a numerical engineering model to describe an event that results in a wellbore failure mode for the well;
running the numerical engineering model to acquire output values for a plurality of the selected sampling points; and
using a fitting technique, constructing a surrogate model based upon at least some of the output values from the selected sampling points.

25. The method of claim 24, further comprising:
utilizing the surrogate model to generate a well operability limit.

26. The method of claim 24, wherein output values for at least some of the selected sampling points are also derived from:
field operations at actual values for at least some of the identified input parameters; and
acquiring data from laboratory experiments at known values for at least some of the identified input parameters.

27. The method of claim 24, wherein the failure mode comprises determining when shear failure or tensile failure of rock associated with a well completion of the well produces sand.

28. The method of claim 24, wherein the failure mode comprises determining one of collapse, crushing, buckling, and shearing of the well due to compaction of reservoir rock as a result of hydrocarbon production.

29. The method of claim 24, wherein the failure mode comprises determining when pressure drop through a near-well completion and in a wellbore of the well hinder the flow of fluids into the wellbore.

30. The method of claim 24, wherein the failure mode comprises determining when pressure drop resulting from flow impairment created by non-Darcy effect, compaction effects, near-wellbore multi-phase flow effects or near-wellbore fines migration effects reduces the flow of fluids from a formation into the well.

31. A method associated with the production of hydrocarbons, comprising:
identifying input parameters for producibility of a well that penetrates at least one hydrocarbon-bearing formation;
selecting a range of values for each of the identified input parameters;
selecting a design of experiments method for filling sampling points within the ranges of values for the identified input parameters;
filling sampling points within the ranges of values for the identified input parameters;
constructing a numerical engineering model to describe an event associated with production through a wellbore of the well;
running the numerical engineering model to acquire output values for a plurality of the selected sampling points;
using a fitting technique, constructing a surrogate model based upon at least some of the output values from the selected sampling points; and
utilizing the surrogate model to generate a well producibility limit.

32. The method of claim 31, wherein output values for at least some of the selected sampling points are also derived from:
field operations at actual values for at least some of the identified input parameters; and
acquiring data from laboratory experiments at known values for at least some of the identified input parameters.

33. The method of claim 31, wherein the step of constructing a surrogate model is performed using one or more of a nested surrogates technique, an n-dimensional tessellation method, or combinations thereof.

34. The method of claim 31, wherein the step of constructing a surrogate model is performed using one or more of a nested surrogates technique, an n-dimensional tessellation method, or combinations thereof.

35. The method of claim 31, wherein the step of constructing a surrogate model is performed using one or more of a nested surrogates technique, an n-dimensional tessellation method, or combinations thereof.
